(19) United States
(12) Patent Application Publication
(10) Pub. No.: US 2004/0153187 A1
(43) Pub. Date: Aug. 5, 2004

(54) Systems and methods for improving planning, scheduling, and supply chain management

(76) Inventors: Thomas Knight, Duluth, GA (US); Don Rosenfield, Lexington, MA (US); Otis Jennings, Durham, NC (US); Steven Graves, Westwood, MA (US); Ian Greenberg, Atlanta, GA (US); John Bishop, Norcross, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/685,670

(22) Filed: Oct. 14, 2003

Related U.S. Application Data
(60) Provisional application No. 60/418,399, filed on Oct. 11, 2002.

(51) Int. Cl. G06F 19/00

(52) U.S. Cl. 700/99; 705/28; 700/102; 700/108; 700/106

(57) ABSTRACT

The invention relates to systems and methods for improving planning, scheduling, and supply chain management. Various embodiments of the invention provide systems and methods for managing inventory of different types of items in a supply chain. One aspect of the invention focuses on a method for managing inventory of similar items in a supply chain. The method includes determining a flow path for items in a supply chain, wherein the flow path comprises at least one operation. The method also includes receiving inventory data for items at each operation; storing the inventory data; determining a demand factor for the items; and determining a cost factor for the items. The method further includes based in part on the demand factor and the cost factor, determining an exchange curve for the items; and displaying a portion of the inventory data for the items and the exchange curve.

### RELATED APPLICATIONS

This application claims priority to U.S. Provisional Application Ser. No. 60/418,399, entitled “SYSTEMS AND METHODS FOR IMPROVING PLANNING, SCHEDULING, AND SUPPLY CHAIN MANAGEMENT,” filed on Oct. 11, 2002.

### FIELD OF THE INVENTION

The invention relates generally to systems and methods for improving planning, scheduling, and supply chain management.

### BACKGROUND OF THE INVENTION

Conventional systems and methods for addressing customer supply chain needs are typically met in one of the following ways. First, simple rules of thumb can be used. Many firms, especially among small companies, use simple rules of thumb for planning and scheduling. For “Buy to Stock”-type firms, an example would be ordering “a month's worth” for each purchased part when inventory drops below “about a week's worth.” While these types of simple rules are relatively easy to remember and easy to implement, they typically lead to poor inventory performance. Often times, inventory is too high in total while many “stock outs” occur. A “stock out” is an instance when there is insufficient inventory for a particular item to fill or meet a customer order or demand for the item.

Next, customized software developed by internal resources can be used. Some firms have developed in-house systems to improve on simple rules of thumb. These types of in-house systems are often customized for the specific industry and manufacturing technology employed. At least one significant downside with these types of systems is that many were developed on older platforms using sometimes obsolete hardware. These “legacy”-type systems are difficult to interface with newer technology, and system maintenance or enhancements are time-consuming and expensive.

Other conventional systems include customized software developed by external resources. This variation of the above option can increase development and maintenance costs.

Next, conventional systems include packaged software such as Enterprise Resource Planning (ERP), Materials Requirements Planning (MRP), or Supply Chain Management (SCM) application programs. Some manufacturing firms have taken the step of utilizing ERP and/or SCM packages. While ERP and MRP packages provide broad functionality, they are weak in planning and scheduling. And while SCM packages improve supply chain management, full-scale SCM/ERP packages require significant investment and implementation costs, usually in excess of $1 million U.S. dollars. ERP vendors are under increasing pressure from customers and competitors to improve their functionality in this area. ERP vendors need to fix problems in their existing ERP packages and compete against best of breed SCM vendors.

Enterprise Resource Planning (ERP) systems, with or without an Advanced Planning and Scheduling (APS) systems, have many problems when it comes to manufacturing logistics. These problems include: (1) Cycle times are considered to be a function of the part in ERP but in actuality depend on the amount of work that exists in the line, the capacity of the line, the raw-process time, and variability. Various shortcuts taken in the development of MRP-type systems have never been adequately addressed even in the most comprehensive ERP systems; (2) Capacity checks are performed ad hoc to the material plans instead of simultaneously; (3) Advanced Planning and Scheduling (APS) systems are notoriously complex and require enormous amounts of data that must be constantly updated—while many APS's take the output of the MRP module and attempt to schedule it to minimize disruption, this and other approaches are, in many ways, “too little, too late.”; (4) The MRP/APS approach is inherently “push” and is therefore susceptible to work in progress (WIP) and cycle time “explosions” as well as missed production opportunities.

Conventional systems and methods to determine inventory sizes face several difficult calculations, such as determining reorder points and reorder quantities. A decision of “make-to-stock” or “make-to-order” is typically a “user input” parameter. That is, a user is required to determine or otherwise input a parameter associated with reorder points and reorder quantities. Likewise, either safety stocks and/or order quantities themselves are considered as user inputs or else parameters such as “order cost” and “inventory carrying cost” are the inputs. In many instances, users have little or no intuition for determining such parameters. It is challenging to many companies to set optimum reorder points and reorder quantities. If too much material is stocked, the company will hold too much inventory, resulting in high investment dollars and a low return on assets. If not enough material is stocked, “stock outs” may occur that often lead to customer dissatisfaction, canceled orders, and/or lost sales. In addition, the correct time to order materials adds another level of complexity. But what makes the problem particularly challenging is that the parameters that most companies deal with are not the same ones used in classical inventory analysis.

Furthermore, many companies have to manage hundreds or even thousands of products. Each of these requires a reorder point and reorder quantity. Companies are often unable to optimize these policies and fall back on simple “rules of thumb” that yield poor results. For example, many companies set reorder quantities based on a target for weeks of supply; as a result, they have too much inventory for some products while stocking out of other products. Thus, a challenging problem to many companies is that total inventory investment must be optimized with respect to an aggregate measure of service.

Some conventional systems and methods for determining inventory sizes assume the user knows parameters such as order cost and backorder cost. However, these parameters are often difficult to calculate or track. Therefore, a need exists for systems and methods for managing inventory of similar items in a supply chain.

In many conventional manufacturing systems, goods or items are composed of multiple parts. Parts of the same type are processed in lots so that plant changeover times and/or costs can be reduced to acceptable levels. However, relatively large sized lots can increase average cycle time as well as the variance in cycle time. There is a delicate balance between having sufficiently long lots, that ensure efficient use of resources, and sufficiently short lots, that allow lower work in progress (WIP) levels and maintain a relatively smoothly flowing system. “Work in progress” is defined as a quantity of goods or items that have not been completely manufactured and are not yet finished goods or items.

Many APS's do not directly address the important issue of cycle time reduction. Lot size can have a significant impact on both the average and variance of cycle times. “Lot size” is defined herein as a defined quantity of parts or materials that are produced at one time. Some conventional systems and methods compute lot sizes based on a model that considers setup “cost” and inventory carrying cost. Because setup cost is usually a surrogate for limited capacity and because classic lot size approaches (e.g., Wagner-Whitin) do not consider capacity, the resulting lot sizes do little to keep cycle times low. Other systems (e.g., i2's Factory Planner) require the lot size values as an input. Appropriate lot sizes are sometimes critical to reducing cycle times and are not at all intuitive.

Legacy-type systems such as ERP systems, utilize conventional lot sizing algorithms (e.g., lot-for-lot, part-period balancing, Groff method, EOQ, etc.). Typically these are good for “make-to-stock” goods and items. However, conventional lot sizing algorithms are not designed to minimize cycle time.

ERP systems and packages typically have one or more modules to help companies with planning, scheduling, and supply chain management. Typically, these modules are built on technology originally developed in the 1970s called Materials Requirements Planning (MRP). MRP was created to help companies determine due dates for raw materials and other inputs. Unfortunately, MRP does not generate good schedules for complex manufacturing environments, as it suffers from assumptions such as infinite capacity and fixed lead times. As a result, MRP has been updated and revised over the years to add functionality. In the 1980's, capacity-planning functionality was included and marketed as Manufacturing Resource Planning (MRP-II). Further features, primarily to integrate with other business functions, were added in the 1990's and called Enterprise Resource Planning (ERP). In the last few years, ERP vendors have marketed additional software commonly called Advanced Planning and Scheduling (APS). APS complements MRP logic with finite capacity scheduling and other tools, but it is built on a weak foundation.

Increasingly, ERP customers have expressed disappointment with ERP implementations, and revenue and market capitalization at major ERP vendors are dropping rapidly. The sales drop-off has been caused by, among other factors: (1) Reduced expenditures in preparation for the Y2K bug since many ERP packages were installed during the late 1990s because legacy systems were not Y2K compliant; and (2) A rise in “best of breed” software—because ERP packages are so broad, they cannot hope to provide the best functionality in every business function they support. In recent years, sales from best of breed vendors in niche functions have surged. Some notable examples are Siebel systems in the Customer Relationship Management, and i2 Technologies in the Supply Chain Management.

Customers increasingly want to tie their business functions to Internet-enabled interfaces and trading partners. But ERP Packages are built on vendor-proprietary database structures, and ERP vendors have been slow to open these standards because it weakens their technology base and invites further competition from best of breed vendors. ERP vendors will increasingly be pushed to work with one of emerging de facto standards for web services and database integration such as Sun's J2EE or Microsoft's .NET.

Given the weaknesses of ERP in planning and scheduling, numerous companies have created software specifically tailored to improve planning, scheduling, and supply chain management. These “best of breed” vendors sell planning and scheduling packages that can be “bolted on” to larger ERP packages and/or legacy systems. The rise of this new class of vendors in the late 1990s has created a new market segment called Supply Chain Management (SCM). These vendors are exploiting ERP weaknesses in the following ways:

As mentioned above, SCM modules in ERP are typically built on MRP, with its limiting assumptions. SCM vendors can develop innovative algorithms unconstrained by this legacy infrastructure.

Most large ERP packages have 18-24 month release cycles and cannot hope to innovate as fast or on as many fronts as smaller SCM vendors.

ERP software often forces customers to adapt their business to fit its software. SCM packages have more limited scope and can therefore be more easily tailored and configured to meet customers' current business processes.

ERP is built for efficient transactions, not effective reporting. SCM packages can focus on reporting data often already collected and stored in legacy ERP systems. SCM vendors can increasingly utilize data already stored in ERP databases.

One of the drivers of ERP growth in the 1990's was its ability to consolidate all the data from a large company into one, monolithic database. In recent years, however, integration technology has made it easier for companies to integrate the data stored in the ERP database with other applications designed for specific business functions. SCM vendors can therefore concentrate on functions for improving planning and scheduling without having to build and support the data collection infrastructure already provided by ERP.

However, there exists a need for systems and methods for improving planning, scheduling, and supply chain management. A further need exists for systems and methods for managing inventory of similar items in a supply chain. A need also exists for systems and methods for managing inventory of different types of items in a supply chain. A need exists for systems and methods for managing lot sizes of multiple types of items in a supply chain. A need also exists for systems and methods for setting stocking policies for similar items in a supply chain. Yet another need exists for systems and methods for setting stocking policies for different types of items in a supply chain. Further, a need exists for systems and methods for managing lot sizes of multiple types of items in a supply chain. Furthermore, a need exists for systems and methods for determining a promise date for an incoming order. A “promise date” is defined as an expected completion date used to predict when an order will be completed, which may or may not be communicated as a commitment or promise to deliver. A need also exists for systems and methods for managing a supply chain for multiple types of items.

### SUMMARY OF THE INVENTION

Systems and methods according to various embodiments of the invention address some or all of the above issues and combinations thereof. They do so by providing systems and methods for improving planning, scheduling, and supply chain management. Further, various embodiments of the invention provide systems and methods for managing inventory of similar items in a supply chain. One aspect of the invention focuses on a method for managing inventory of similar items in a supply chain. The method includes determining a flow path for items in a supply chain, wherein the flow path comprises at least one operation. The method also includes receiving inventory data for items at each operation; storing the inventory data; determining a demand factor for the items; and determining a cost factor for the items. The method further includes based in part on the demand factor and the cost factor, determining an exchange curve for the items; and displaying a portion of the inventory data for the items and the exchange curve.

Another particular aspect of the invention includes a method for managing inventory of different types of items in a supply chain. The method includes receiving inventory data for items of a first type at an operation; receiving inventory data for items of a second type at an operation; and storing the inventory data for the items of the first type and second type. The method also includes determining demand factors for the items of the first type and second type; determining cost factors for the items of the first type and second type; and based in part on the demand factors and the cost factors, determining a first exchange curve for the items of the first type and a second exchange curve for the items of the second type. Further, the method includes displaying a portion of the inventory data for the items of the first and second types, and the exchange curves for the items of the first and second types.

Another aspect of the invention includes a method for managing lot sizes of similar items in a supply chain, wherein the supply chain includes at least one station. The method includes determining an initial lot size for items at a first station; receiving routing data for items at each station; and storing the routing data. Further, the method includes based on the routing data, determining a cycle time for the items flowing from the first station through the supply chain; and based on at least the cycle time for the items flowing from the first station through the supply chain, selecting a desired cycle time for the items. The method also includes based on at least the selected desired cycle time for the items, adjusting the initial lot size for the items at the first station.

Another particular aspect of the invention is a method for managing lot sizes of multiple types of items in a supply chain, wherein the supply chain includes at least one station. The method includes determining an initial lot size for a first type of item at a first station; determining an initial lot size for a second type of item at the first station; receiving routing data for each type of item as the items flow from the first station through the supply chain; and storing the routing data. The method also includes based on the routing data, determining a cycle time for each type of item flowing from the first station through the supply chain; and based on at least the cycle time for the items flowing from the first station through the supply chain, selecting a desired cycle time for each type of item. Further, the method includes based on at least the desired cycle time for each type of item, adjusting the initial lot size for each type of item at the first station.

Yet another aspect of the invention includes a method for determining a promise date for an incoming order, wherein the supply chain includes at least one station. The method includes determining production time for an item at a station; determining setup time for the item at the station; and determining cumulative available capacity. The method also includes determining booked capacity; determining a difference between the cumulative available capacity and booked capacity, and adjusting the difference by at least the production time for an item at the station and setup time for the item at the station; and based in part on the difference, determining a minimum lead time for an incoming order.

Another aspect of the invention is a method for managing a supply chain for multiple types of items. The method includes determining a flow path for each type of item in a supply chain, wherein each flow path includes operations. The method includes receiving performance data for each type of item at each operation; storing the performance data; processing the performance data to obtain a determination selected from a group consisting of: an exchange curve showing a tradeoff in alternative stocking policies, a lot size optimization and WIP level tradeoff curve, and a promise date; and displaying a portion of the performance data for the items and the determination.

Features and advantages of various systems and methods according to various embodiments of the invention include:

(1) providing systems and methods for improving planning, scheduling, and supply chain management;

(2) providing systems and methods for managing inventory of similar items in a supply chain;

(3) providing systems and methods for managing inventory of different types of items in a supply chain;

(4) providing systems and methods for setting stocking policies for similar items in a supply chain;

(5) providing systems and methods for setting stocking policies for different types of items in a supply chain;

(6) providing systems and methods for managing lot sizes of multiple types of items in a supply chain;

(7) providing for systems and methods for managing lot sizes of multiple types of items in a supply chain;

(8) providing systems and methods for determining a promise date for an incoming order; and

(9) providing systems and methods for managing a supply chain for multiple types of items.

Other features and advantages of various aspects and embodiments of systems and methods according to the invention are apparent from the other parts of this document. The invention may be understood more readily by reference to the following detailed description included herein. Although the invention has been described with reference to specific details of certain embodiments thereof, it is not intended that such details should be regarded as limitations upon the scope of the invention. The entire text of any references mentioned herein are hereby incorporated in their entireties by reference.

### BRIEF DESCRIPTION OF THE DRAWINGS

FIG. 1 is a functional block diagram of an exemplary system according to various embodiments of the invention.

FIG. 2 illustrates a schematic of an exemplary planning hierarchy for a system according to various embodiments of the invention.

FIG. 3 is an illustration of a graphical chart provided by an exemplary system and method in accordance with an embodiment of the invention.

FIG. 4A is a flowchart of an exemplary method according to various embodiments of the invention.

FIG. 4B is a flowchart of another exemplary method according to various embodiments of the invention.

FIG. 4C is a flowchart of another exemplary method according to various embodiments of the invention.

FIG. 5 is a screenshot of an exemplary user interface for methods and systems according to various embodiments of the invention.

FIG. 6 is a lower portion of the screenshot shown in FIG. 5.

FIG. 7 is another screenshot of an exemplary user interface for methods and systems according to various embodiments of the invention.

FIG. 8 is an illustration of another graphical chart provided by an exemplary system and method in accordance with an embodiment of the invention.

FIG. 9A is a flowchart of another exemplary method according to various embodiments of the invention.

FIG. 9B is a flowchart of another exemplary method according to various embodiments of the invention.

FIG. 10 is a screenshot of another exemplary user interface for methods and systems according to various embodiments of the invention.

FIG. 11 is a lower portion of the screenshot shown in FIG. 10.

FIG. 12 is a flowchart of another exemplary method according to various embodiments of the invention.

### DETAILED DESCRIPTION

The invention relates generally to systems and methods for improving planning, scheduling, and supply chain management. According to a preferred embodiment of the invention, a system is described as a Flow Path Management System (FPMS) or a Supply Chain Management System (SCMS). The systems and methods according to the invention may relate to the FPMS by itself and/or in combination with an Enterprise Resource Planning (ERP) system or Supply Chain Management (SCM) system. Furthermore, the systems and methods according to the invention may relate to modules within the FPMS alone or combinations of those modules. For instance, these modules include, but are not limited to, sequencing, first time through, inventory advisor (IA), lot size and work in progress estimator (LWE), and promise date finder (PDF). In general, the sequencing module is used to sequence production orders to minimize change over times while meeting customer due dates. The first time through module is used to report quality issues and corrective actions. The inventory advisor module is used to determine which products should be made to order and which should be made to stock. The inventory advisor module also sets reorder points and reorder quantities for make to stock products. The LWE module (a) identifies constrained resources, (b) optimizes how many products should be produced together to minimize setups while meeting output goals, and (c) optimizes WIP levels to reach throughput and cycle time objectives. The PDF module is used to set lead times for incoming orders.

The systems and methods according to the invention may be provided to customers in various ways. For example, the systems and methods may be provided as a stand alone system or as part of an existing stand alone system. The systems and methods may also be provided on a network, such as an Intranet, Local Area Network, or Wide Area Network. The networks also include wireless networks, such as mobile radiotelephone networks, wireless data networks, satellite networks, etc. Thus, users may access the systems and methods according to the invention in various ways, including personal computers, personal digital assistant (PDA), pocket PCs, Palm devices, 3G devices, WAP-enabled phones, WebTV, and other data, communication, or entertainment devices. Furthermore, the systems and methods may be provided to customers through the Internet, such as through an Application Service Provider (ASP). The systems and methods may be sold, licensed, rented, or otherwise provided to users.

Users of the systems and methods include, but are not limited to, buyers, planners, and schedulers at manufacturing-type companies. In general, some or all of these companies can be categorized as “buy to stock” companies, “make to stock” manufacturers, and “make to order” manufacturers. These customers and users are merely exemplary and the invention encompasses other types of users, companies, and other entities that may benefit from the systems and methods.

In many instances, a supply-chain can be represented as a collection of flow paths. A “flow path” is defined herein as a network of resources through which goods or items flow. Note that a flow path is more general than a flow line in that parts can enter and exit at multiple points in a designated path. By selecting one or more flow paths and then developing models of flow path behavior, a robust and effective production planning system is modeled. The designation of the flow paths, the models, and associated software implemented for production planning make up a flow path management system.

Note that a flow path management system in accordance with an embodiment of the invention focuses on wholesale/retail operations that sell from a stock of inventory, and also focuses on manufacturing operations involving fabrication and/or assembly that have unidirectional flow paths, i.e., parts flow in only one direction along the flow path. These types of “unidirectional” flow path environments include a broad range of manufacturing-type companies, from aluminum rolling mills to pharmaceutical plants.

The flow path management functionality in FPMS allows an authorized user to define a single or multiple flow paths. A user does this by selecting a group (or subset) of products or items from an available set of all products or items at a given plant, and also selects a group (or subset) of work centers visited by that subset of products or items during the manufacturing process.

These products (or items) and work centers are selected from the universe (available) set of all products (or items) and work centers in the particular plant. The flow paths definitions include, but are not limited to, a single plant scope, especially if a given subset of products or items is routed through multiple plants in their production cycle. By way of example, the definition of a flow path can be expressed as follows:

FPᵣ(Pᵢ,WCⱼ)={Pᵢ:(i|i=1,2,3, . . . , k)}∩{WCⱼ:(j|j=1,2,3, . . . ,n)}

where: k=total number of products or items produced in a plant

n=total number of work centers in a plant

r=1,2,3, . . .

P=universe of all products or items in a plant

Pᵢ=a discrete subset of products or items

WC=universe of work centers in a plant

WCⱼ=a discrete subset of work centers

FP=all defined flow paths;

FPᵣ=a discrete flow path defined by subset of products or items that visit subset of work centers

If Pᵢ∈FPᵣ, then P_{i l ∉FP}ᵣ₊₁ (Exclusion—a product or item can belong to only one flow path). In other words, a flow path is a function of products and work centers, such that a discrete sets of products or items intersect (visit) with a discrete number of work centers during the manufacturing process.

Note that a “product,” “good,” and “item” all refer to an object that will be or that is being manufactured in a plant. The terms, “product,” “good,” and “item,” are used interchangeably throughout the text of the specification. Note that a “work center” can also be an “operation” or “station,” and these terms are also used interchangeably throughout the text of the specification.

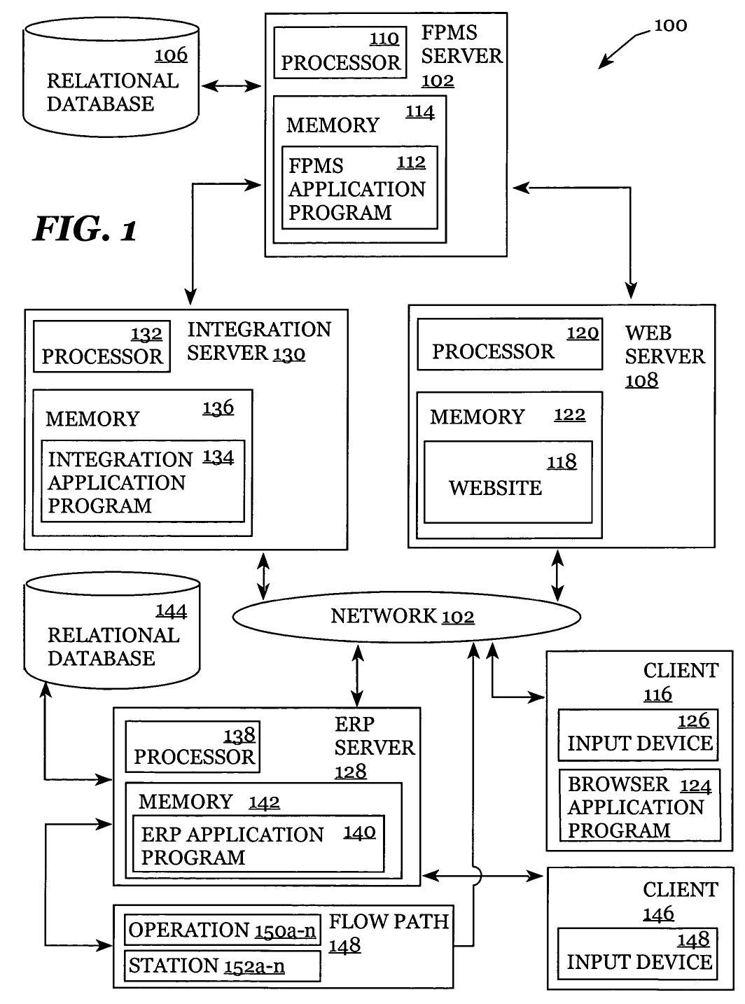

Various systems in accordance with the invention may be constructed. FIG. 1 is a diagram illustrating an exemplary system 100 in which exemplary embodiments of the invention may operate. The invention may operate and can be embodied in other systems as well. Reference will now be made in detail to exemplary embodiments of the invention as illustrated in the accompanying drawings. The same reference numbers are used throughout the drawings and the following description to refer to the same or like parts.

An example of a system 100 in accordance with various embodiments of the invention is illustrated in the context of a networked computer environment. Other environments exist in which other systems in accordance with various embodiments of the invention can be implemented. The system 100 shown is a flow path management system adapted to operate in conjunction with a computer network 102. The system 100 includes a flow path management system (FPMS) server 104, a relational database 106, and a web server 108. Other components may be present in a system in accordance with various embodiments of the invention.

The flow path management system (FPMS) server 104 includes a processor 110 which executes one or more software program modules such as a FPMS application program 112 stored in memory 114. The FPMS application program 112 is a set of computer-executable instructions or software programs adapted to improve planning, scheduling, and supply chain management. The FPMS application program 112 can include one or more program modules such as, but not limited to, inventory advisor (IA), lot size and work in progress (WIP) estimator, promise date finder (PDF), sequencing, and first time through. Each of these modules provides a supply chain planning tool. Note that some or all of the various modules of the FPMS application program 112 can execute and operate from the same or different processor-based platforms. The FPMS application program 112 can operate on any processor-based platform such as the FPMS server 104, another server, a client 116, or a remotely located processor-based device.

The FPMS server 104 is in communication with one or more databases or data storage devices such as the relational database 106. Furthermore, the FPMS server 106 is also in communication with the network 102, the Internet, an intranet, or another network. Through the relational database 106 or via the network 102, the 20 FPMS server 104 receives various data inputs from at least one user operating a client 116. Note that data inputs can also be selection data inputs where the user selects and inputs various data to the client 116. Data and selection data inputs will be referred collectively as “data inputs” or “selection data inputs.” Data inputs can include, but are not limited to, demand information, supply information, and supply chain information. Memory 114 and/or relational database 106 stores data inputs received via the network 102 or directly from another source. Other types of data inputs can also be derived, ascertained, or otherwise received and then stored by the FPMS server 104 and its associated components in accordance with various embodiments of the invention.

The web server 108 is in communication with the FPMS server 104 and the network 102. The web server 108 is adapted to host a website 118 to receive data inputs via the network 102. The web server 108 includes a processor 120 and memory 122. In general, the website 118 is accessible by one or more clients 116 in communication with the web server 108 via the network 102.

The client 116 executes a browser application program 124 such as Internet Explorer™, version 6.0 from Microsoft Corporation; Netscape Navigator™, version 7.1 from Netscape Communications Corporation; and Safari™, version 1.0 from Apple Computer, or other type of browser program for viewing or accessing functionality of the website 118. Users can access the client 116 to utilize the browser application program 124 to view the website 118. Data inputs from a user can be entered via an input device 126 included with the client 116. An input device can include, but is not limited to, a mouse, touch pad, keyboard, touch screen, pointer, voice recognition, scanner, bar code reader, or similar type input device. Note that one or more clients 116 can be in communication with the FPMS server 106, either through the network 102, through the web server 108, direct connectivity, wireless communications, the Internet, or another communications-type network.

One or more legacy-type systems such as a ERP server 128 or SCM server can be in communication with the FPMS server 104. Legacy-type systems are pre-existing inventory management systems that have been installed and operate at a company. Each legacy-type system collects, stores, and processes inventory data in accordance with the respective legacy-type system's operating system, data format, and protocol. Since legacy-type systems can have different operating systems, data formats, and incompatible protocols, the system 100 utilizes an integration server 130 to handle previously stored and processed data from a legacy-type system. The system 100 is adapted to integrate with an existing ERP system using Enterprise Application Integration-type (EAI) technology.

For example, the FPMS server 106 is in communication with the integration server 130. The integration server 130 is a processor-based platform adapted to integrate previously stored data from a legacy-type system with data used by the FPMS application program 104. The integration server 130 includes a processor 132, and an integration application program 134 stored in a memory 136. The integration application program 134 is a set of computer-executable instructions for integrating data inputs from a legacy-type system with data inputs handled by the FPMS application program 104. The integration server 130 communicates with a ERP server 128 either through the network 102, direct connectivity, wireless communications, the Internet, or another communications-type network. The integration server 130 pre-processes data input received from legacy-type systems such as the ERP server 128. The data input previously stored by a legacy-type system such as the ERP server 128 can then be processed by the FPMS application program 112.

In general, the ERP server 128 can include a processor 138, and an ERP application program 140 stored in a memory 142. Data inputs can be stored in the memory 142 or in an ERP relational database 144. The ERP application program 140 is a set of computer-executable instructions for receiving and processing data inputs from a legacy-type system. Other components may exist within or in conjunction with the ERP server. These include, but are not limited to, a SCM system, a Manufacturing Execution System (MES), a Product Lifecycle Management (PLM) system, Customer Relationship Management (CRM) system, or any device or server implementing one or more of these systems. In some instances, a legacy-type system may still be in operation at a manufacturing facility or a company. For example, data inputs previously entered at a ERP client 146 via an associated input device 148 can be transmitted to the ERP server 128 for storage in memory 142 or relational database 144. The ERP application program 140 may process the data inputs according to legacy-type methods, data formats, and protocols. The integration server 130 retrieves or otherwise accesses the data inputs from the ERP server 128, memory 142, or relational database 144 via the network 102 or by direct connectivity. Legacy data processed by the integration application program 134 can then be handled by the FPMS application program 104. Those skilled in the art will recognize the various methods and devices needed to integrate legacy data with the system 100 in accordance with various embodiments of the invention.

The ERP server 128 and/or network 102 is in communication with at least one predefined flow path 148. The flow path 148 includes one or more work stations such as operations 150a-n and/or stations 152a-n. As described above, one or more flow paths can exist in a supply chain. Each flow path is includes work stations such as operations 150a-n and/or stations 152a-n that a product, item, or good can flow or otherwise be routed through. Inventory data, performance data, routing data, or other data inputs can be determined by or otherwise received from the operations 150a-n and stations 152a-n, and transmitted to the FPMS application program 112 via the ERP server 128 and/or network 102. In some instances, such data can be transmitted directly to the FPMS application program 112 from the flow path 148, or otherwise be directly received from the flow path 148. Those skilled in the art will recognize the methods and devices utilized to transmit and receive such data.

Other components than those described above may communicate with and operate in conjunction with the FPMS server 104 and FPMS application program 112 in accordance with various embodiments of the invention. Note that those skilled in the art will also recognize that systems and methods in accordance with various embodiments of the invention may be implemented in hardware, software, and/or a combination thereof.

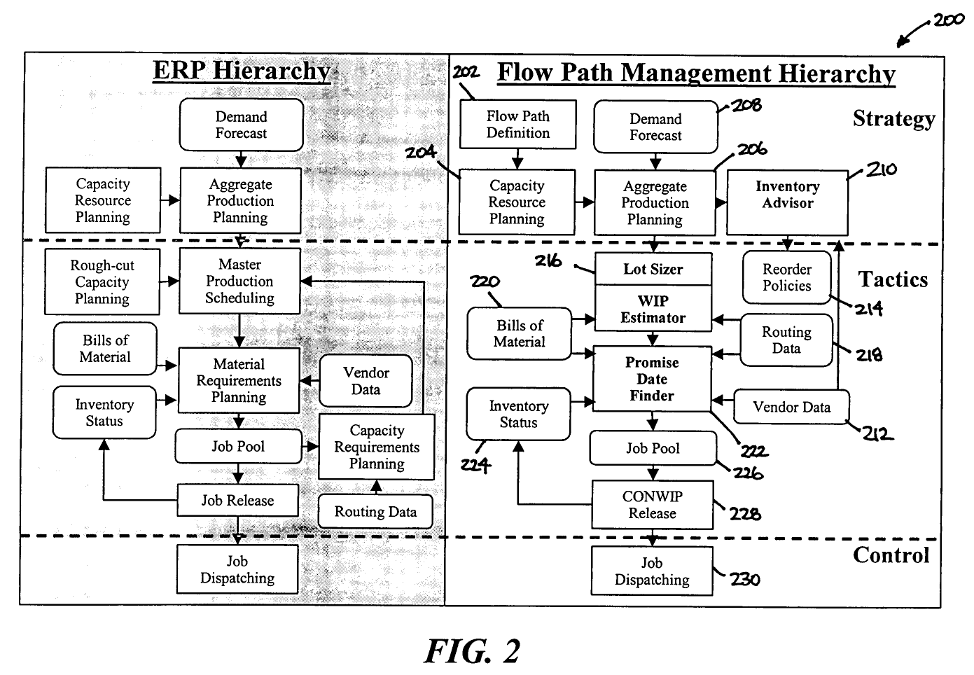

FIG. 2 illustrates a schematic of an exemplary planning hierarchy for an exemplary system in accordance with various embodiments of the invention. The method 200 can be implemented by the system 100 shown in FIG. 1. By way of further example, the method 200 can be implemented by a flow path management system (FPMS) application program 112 operating in conjunction with an ERP application program 140 according to various embodiments of the invention. The method 200 can be characterized by at least three functional layers: strategy, tactics, and control. Fewer or greater numbers of functional layers can be provided, and different layers of functionality may be provided as well. Collectively, the strategy, tactics, and control functionalities represent a method for managing a flow path in a supply chain. Blocks 202-210 of method 200 represent strategy-type functionality, blocks 212-228 represent tactics-type functionality, and block 230 represents control-type functionality.

The method 200 begins at block 202, in which a flow path is defined. The flow path management system (FPMS) application program 112 defines a flow path for at least one item in a supply chain. Those skilled in the art will recognize the methods and devices needed to define a flow path.

Block 202 is followed by block 204, in which capacity resource planning is performed. The FPMS application program 112 performs capacity resource planning by displaying work center utilization within a LWE module.

Block 204 is followed by block 206, in which aggregate production planning is performed. The FPMS application program 112 performs aggregate production planning by displaying product demand and work center utilization within the LWE module.

Also leading to block 206, block 208 provides a demand forecast to aggregate production planning. The FPMS application program 112 determines the demand forecast.

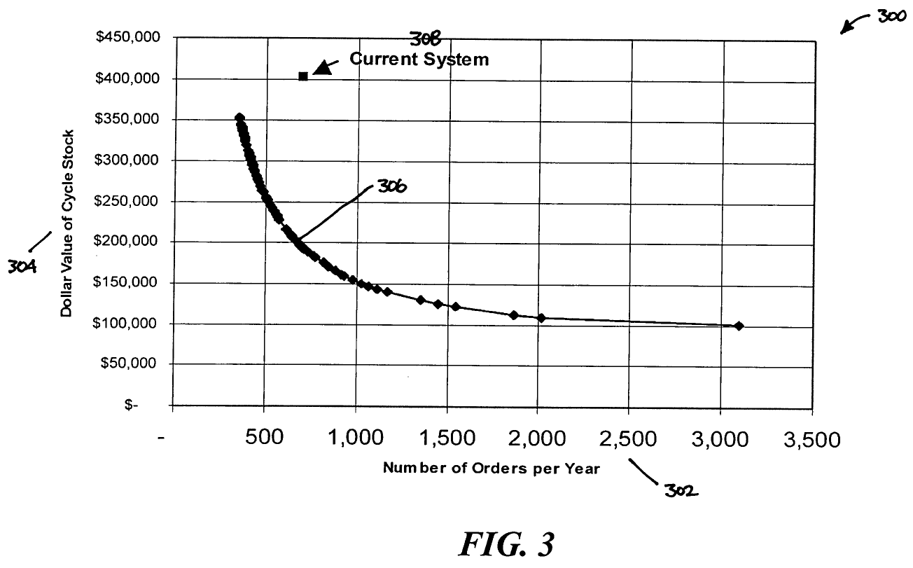

Block 206 is followed by block 210, in which an inventory advisor module executes. The FPMS application program 112 executes the inventory advisor module. The inventory advisor module 210 is described greater detail below with respect to FIGS. 3-6.

Also leading to block 210, block 212 provides vendor data to the inventory advisor module. The FPMS application program 112 provides vendor data to the inventory advisor module.

Block 212 is followed by block 214, in which reorder policies are set. The FPMS application program 112 executes the inventory advisor module, which sets reorder policies, as described in greater detail below with respect to FIGS. 3-6.

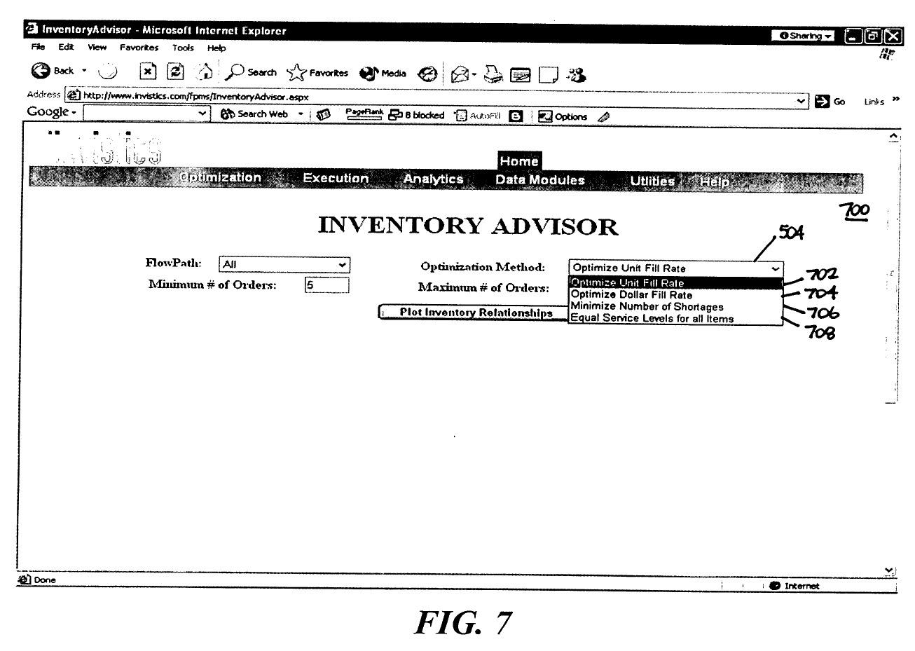

Referring back to block 206, block 206 is also followed by block 216, in which a lot size and WIP estimator (LWE) module executes. The FPMS application program 112 executes the lot sizer and WIP estimator (LWE) module 216. The lot size and WIP estimator (LWE) module 216 is described greater detail below with respect to FIGS. 7-9.

Also leading to block 216, block 218 provides routing data. The FPMS application program 112 determines routing data and provides the data to the lot size and WIP estimator (LWE) module 216, as described in greater detail below with respect to FIGS. 7-9.

Furthermore, also leading to block 216, block 220 provides bills of material. The FPMS application program 112 provides bills of materials to the lot size and WIP estimator (LWE) module 216, as described in greater detail below with respect to FIGS. 7-9.

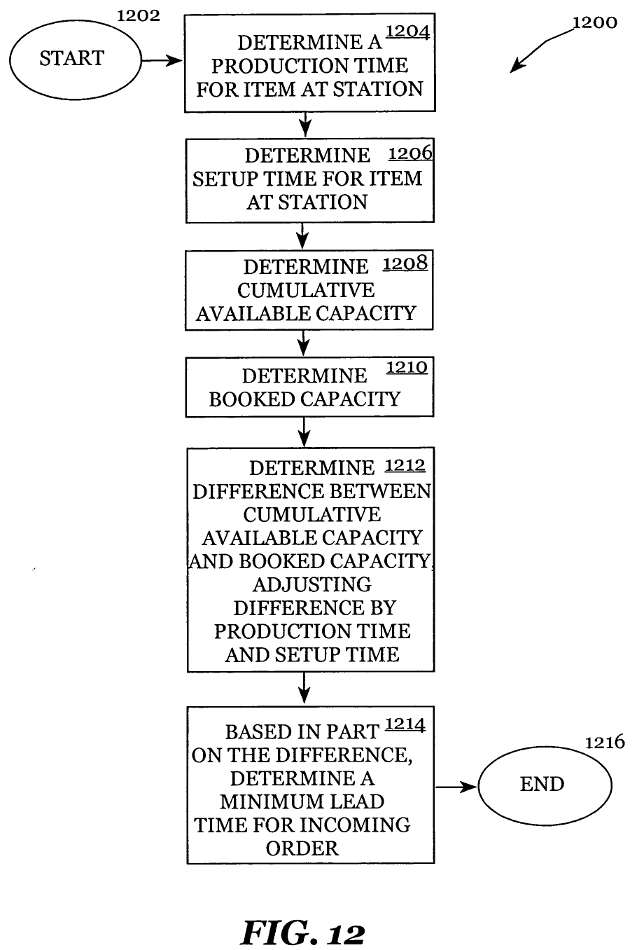

Block 214 is followed by block 222, in which a promise date finder module (PDF) executes. The FPMS application program 112 executes the promise date finder module (PDF) 222. The promise date finder (PDF) module 222 is described greater detail below with respect to FIG. 12.

Also leading to block 222, block 224 provides inventory status. The FPMS application program 112 provides the inventory status to the promise date finder (PDF) module 222, as described greater detail below with respect to FIGS. 12.

Block 224 is followed by block 226, in which CONWIP release is implemented. The FPMS application program 112 implements the CONWIP release.

Block 226 is followed by blocks 222 and 230. In block 222, the method 200 returns to inventory status, which is followed by block 222, in which a promise date finder module executes, and the method 200 continues. In block 230, job dispatching is performed and the method 200 ends. The FPMS application program 112 determines job dispatching.

Referring to particular modules shown in FIG. 2, one module associated with the FPMS application program 112 is the inventory advisor module 210. Based on data input from aggregate production planning and other sources shown in block 206, the inventory advisor module 210 determines and sets stocking polices, reorder points, and reorder quantities. The inventory advisor module 210 also determines, based on demand and cost, which goods or items should be “make to stock” and which goods or items should be “make to order.” If a determination is made that a particular good or item is to be “made to stock,” the inventory advisor module 210 determines the reorder points and reorder quantities for the particular good or item. The inventory advisor module 210 can be implemented in an environment with fixed lead times such as when a company is purchasing raw materials or finished goods from vendors.

The inventory advisor module 210 also provides a user with one or more graphical plots of an “efficient frontier” of particular measures such as cycle stock inventory cost versus number of orders per year and safety stock inventory versus customer service rate. Based on inventory and other performance measures, the inventory advisor module 210 determines and displays at least one exchange curve. The user can then select a point along or adjacent to the exchange curve in which to manage inventory or set stocking policies for a good or item. An example of an exchange curve is shown as 300 in FIG. 3.

Referring to FIG. 3, a horizontal x-axis 302 shown represents number of orders per year for a particular good or item. A left-side vertical y-axis 304 represents a dollar value of cycle stock for the particular good or item. A first graphical plot 306 or “exchange curve” represents a particular number of orders per year versus dollar value of cycle stock. A second graphical plot 308 represents a performance measure of where a current system operates. Using the two plots 306, 308, a user such as a planner can compare the performance of a current inventory system against an exchange curve representing one or more “optimum” or “efficient” performance measures plotted versus each other. In the particular example shown in FIG. 3, the graphical plot 308 of the current inventory system performance is shown slightly above the graphical plot 306 for an optimum exchange curve or “efficient frontier.” The relative amount of deviation from the exchange curve is indicative of the difference between the current inventory system performance and measure of an optimum or maximum efficiency. Although other practical considerations (e.g., minimum order quantities) may prevent a company from achieving maximum efficiency, the comparison between graphical plots 306, 308 shows that there is a potential for improvement in the inventory decision, and the user can select a point along or adjacent to the exchange curve to operate at.

The inventory advisor module 210 builds upon and offers a user a set of exchange curves and then utilizes heuristics that can be incorporated in a database such as a relational database 106. Often times, previously stored heuristics already exist in an associated ERP server 128 or system.

The following equations 1.1-1.3 represent heuristics utilized by an ERP server 128 or system, and are provided by way of example. Other equations or algorithms may be used with various embodiments of the invention. In this example, the “economic order quantity” (EOQ) for product i having demand Dᵢ and unit cost of cᵢ can be determined as:

$${Q}_{i}^{*} = \sqrt{\frac{2 {AD}_{i}}{{hc}_{i}}} \qquad ( 1.1 )$$

where alpha or A is the “order cost” and h is the “inventory carrying cost ratio.” Estimating the value of “order cost,” alpha, or A is often difficult. However, by varying the ratio of “2A/h,” an exchange curve similar to 306 can be determined to compare total cycle stock cost versus number of orders per year without ever specifying or calculating a value for “order cost,” alpha, or A.

The total average cycle stock inventory cost can then be determined as:

ΣⱼcⱼQⱼ/2 (1.2)

The average number of orders per year can be determined as:

ΣⱼDⱼ/Qⱼ. (1.3)

Once an exchange curve is determined, a user viewing the exchange curve then decides where she wants to be along or adjacent to the exchange curve. A corresponding user input can be received via an input device 126 or a website 118, and the user's input or decision can be implemented with respect to inventory for a good or item.

Likewise, a “penalty cost” parameter, beta, or b is often difficult to calculate or determine. However, an exchange curve similar to 306 shown in FIG. 3 showing the total investment in safety stock versus the expected total number of stock outs per year can be determined instead of specifying a value for “penalty cost,” beta, or b. Once an exchange curve is determined, a user viewing the exchange curve then decides where she wants to be along or adjacent to the exchange curve. A corresponding user input can be received via an input device 126 or a website 118, and the user's input or decision can be implemented with respect to inventory for a good or item.

Thus, the inventory advisor module 210 reports current performance data measures (such as orders per year, fill rate, and inventory investment) and then sets constraints on at least two of these performance data measures and then optimizes the third performance data measure. Note that the inventory advisor module 210 can be implemented to handle multiple items in a flow path, and by trading off inventory and service among each of the items, improved inventory decisions can be made and processed by the system 100.

In another example, assume a customer desires to meet or exceed a required fill rate, S₀, with no more than a given number of orders per year, w₀, while minimizing total inventory investment. This example involves multiple variables for the inventory advisor module 202 to process and to determine a corresponding exchange curve for. A mean and variance of the lead time demand, D, is determined for an assumed compound demand process, \tilde{D} and Y , where \tilde{D} is the random variable representing the number of orders in a period, and Y is the size of the order. The mean of \tilde{D} is λ, and the variance is \tilde{ψ}²λ. Likewise, E[Y]=μ_{Γ}, and V[Y]=φ²μ_{Y}². The lead-time is constant and is equal to l. The following equations are used:

θ=E[D]=λμ_{Y}l σ²=V[D]=(λ□□φ²+\tilde{ψ}²)μ_{Y}²l (2.1)

If the lead times are random, with E[L]=l, and V[L]=σₗ² then the following equation is used:

σ²=V[D]=□(λ□□φ²−\tilde{ψ}²)μ_{Y}₂l+(λμ_{Y})²σₗ² (2.2)

The above equation 2.2 is then used to determine the mean and variance of a Normal distribution, which then approximates the compound Poisson. Using a Zipkin notation with cᵢ as the cost of item i and the other parameters indexed for i, the multiple variable problem to minimize inventory can be characterized as:

$$min Z = {\sum }_{i} {c}_{i} I ( {Q}_{i} , {r}_{i} , {θ}_{i} , {σ}_{i} ) \qquad ( 2.3 )$$

subject to the total number of orders being limited to w₀

Σλᵢμ_{Yi}/Qᵢ≦wₒ (2.4)

and the fill rate as a function of the reorder quantity and reorder point being at least as good as S₀.

The reorder quantities and reorder points are computed from:

Qᵢ=\sqrt{Aλᵢμ_{Yi}/cᵢ} and rᵢ=θᵢ−Φ⁻¹(πᵢ) (2.5)

where πᵢ=bλᵢμ_{Yi}/(bλᵢμ_{Yi}+cᵢQᵢ). To determine an exchange curve for the above example, the variable A is optimized to meet the first constraint, and variable b is optimized to meet the second constraint. The concept is to adjust the “set-up cost” parameter A and “penalty cost” parameter b to more practical parameters of “turns” and “fill rates.” This type of heuristic determines values usually within approximately 5% of an optimal inventory policy.

In another example, a “near optimal” inventory policy recommended by an inventory advisor module 202 to a company targeting 8 turns per year and approximately 99.9% fill rate had approximately 75% smaller inventory investment with slightly fewer orders per year and a slightly better fill rate than the common inventory policy.

Note that the equations 1.1-1.3, and 2.1-2.5 are provided by way of example only. An exchange curve can be determined or otherwise generated using other equations, combinations of the above equations, or variations of the equations provided above. The above examples are not intended to be a limitation of the disclosed methods used by the invention to determine an exchange curve.

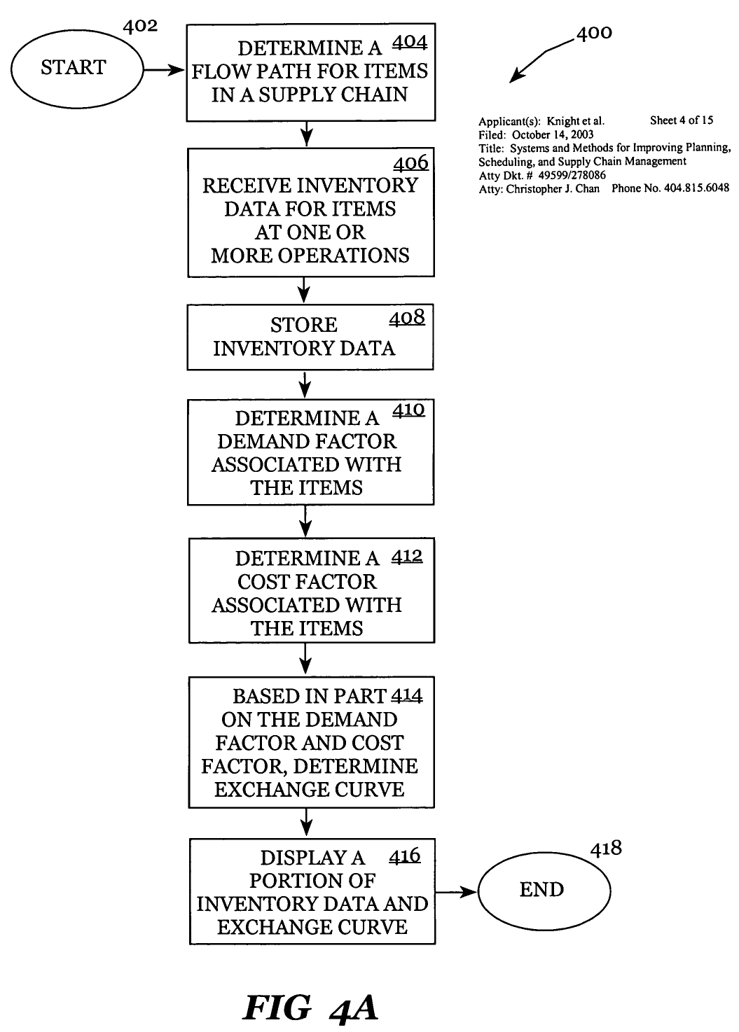

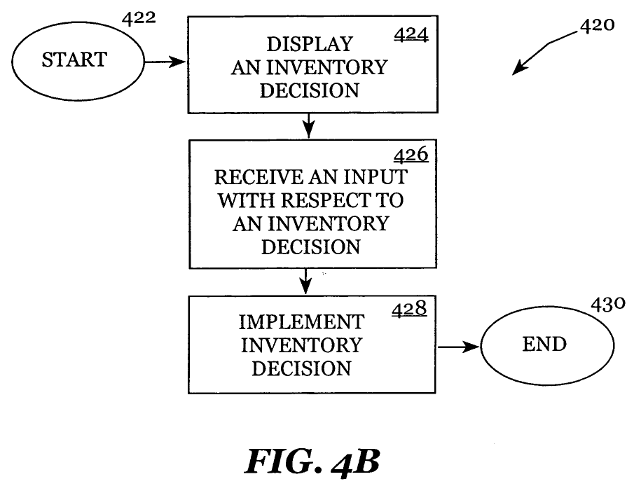

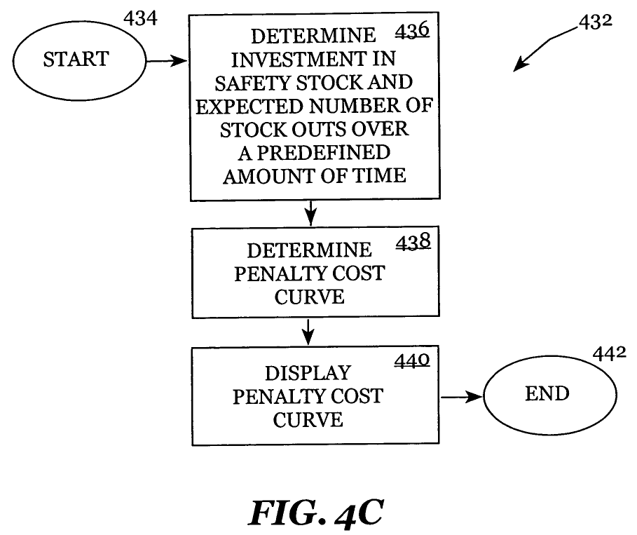

Referring to FIG. 4A, an exemplary method 400 according to various embodiments of the invention is shown. The method 400 is adapted to manage inventory or set stocking policies of similar items in a supply chain. In the embodiment shown, the method 400 can be performed by the system embodiment shown as 100 in FIG. 1. By way of example, reference will be made to elements of the system 100 shown in FIG. 1.

The method 400 begins at block 402.

Block 402 is followed by block 404, a flow path for items in a supply chain is determined. The inventory advisor module 210 determines a flow path for an item. The flow path includes at least one operation, and in most cases includes multiple operations. Conventional systems and methods for determining a flow path in a supply chain can be implemented.

Block 404 is followed by block 406, in which inventory data for items at each operation is received. The inventory advisor module 210 receives inventory data associated with items in a flow path via a network 102, an ERP server 128, ERP application program 140, or database 106, 144. Inventory data can include, but is not limited to, data inputs, selection data, orders per time period, cycle stock costs, variability and mean unit costs, flow path assignment, units of measure of throughput of cycle time, lead time, and minimum and maximum lot sizes.

Block 406 is followed by block 408, in which the inventory data is stored. The inventory advisor module 210 stores received inventory data in memory 114, or a relational database 106 for subsequent processing. Other memory or data storage type devices can be used in accordance with various embodiments of the invention.

Block 408 is followed by block 410, in which a demand factor for the items is determined. The inventory advisor module 210 determines a demand factor associated with the items. Utilizing some or all of the inventory data, the inventory advisor module 210 applies one or more algorithms such as those illustrated in equations 2.1 and 2.2 above to determine a demand factor. A demand factor can include, but is not limited to, a number of orders for items over a predefined period of time, the expected demand during the reorder lead time, and the distribution of the demand as a random variable.

Block 410 is followed by block 412, in which a cost factor for the items is determined. The inventory advisor module 210 determines a cost factor associated with the items. Utilizing some or all of the inventory data, the inventory advisor module 210 applies one or more algorithms such as those illustrated in equations 2.1 and 2.2 above to determine a cost factor. A cost factor can include, but is not limited to, a total cycle stock cost for items, a total safety stock cost for items, or a weighted average of these two values plus other cost driving such as transportation, storage, and stock out costs.

Block 412 is followed by block 414, in which based in part on the demand factor and the cost factor, an exchange curve for the items is determined. The inventory advisor module 210 determines an exchange curve based in part on the demand factor determined above at block 408 and the cost factor determined above at block 410. An exchange curve can be generated or otherwise determined to illustrate inventory data associated with the demand factor and cost factor.

Block 414 is followed by block 416, in which a portion of the inventory data for the items and the exchange curve is displayed. Once the exchange curve is determined, the inventory advisor module 210 can display the exchange curve on a website 118 for viewing by a user at a display device (not shown) associated with the client 116.

Block 416 is followed by block 418, in which the method 400 ends.

After method 400 displays the exchange curve, another method 420 can be performed to utilize the exchange curve. FIG. 4B illustrates the method 420.

At block 422, the method 420 begins. Block 422 is followed by block 424, in which at least one inventory decision with respect to items in the supply chain is displayed. After the inventory advisor module 210 displays the exchange curve, the user can select various points along or adjacent to the exchange curve. Each point represents an operating point associated with various performance measures that the system 100 can operate at. Using an input device 126 at a client 116, the user can highlight or select a point along or adjacent to the exchange curve. When the user highlights or selects a particular point, performance data associated with the particular point along or adjacent to the exchange curve is displayed. The performance data associated with the particular point represents a potential inventory decision that the user can select. An inventory decision can include, but is not limited to, make an item to order and make an item to stock.

Block 424 is followed by block 426, in which a user input corresponding to an inventory decision is received. If the user decides upon a particular point along or adjacent to an exchange curve, the user selects the point by transmitting a data input via the input device 126. The client 116 transmits associated information corresponding to the inventory decision with respect to the point along or adjacent to the exchange curve.

Block 426 is followed by block 428, in which depending on the inventory decision, the inventory decision is implemented with respect to items at an operation. The website 118 receives the data input from the client 116, and transmits the data input to the FPMS application program 112. The FPMS application program 112 transmits commands to an operation in a flow path or along a supply chain that corresponds with the inventory decision selected by the user.

Block 428 is followed by block 430, in which the method 420 ends.

After method 400 displays the exchange curve, another method 432 can be performed. FIG. 4C illustrates the method 432.

At block 434, the method 432 begins. Block 434 is followed by block 436, in which an investment in a safety stock and an expected number of stock outs over a period of a predefined time is determined. After the inventory advisor module 210 displays the exchange curve, the user can opt to view performance data showing safety stock and an expected number of stock outs over a period of a predefined time. The inventory advisor module 210 determines an additional curve corresponding to this performance data.

Block 436 is followed by block 438, in which based on investment in the safety stock and expected number of stock outs per period of a predefined time, a penalty cost curve is determined. The inventory advisor module 210 determines an additional curve corresponding to this performance data. For example, the formulas described above with respect to beta or b can be used to determine the penalty cost curve.

Block 438 is followed by block 440, in which a portion of the inventory data for the items and the penalty cost curve is displayed. Once a penalty cost curve is determined, the inventory advisor module 210 can display the penalty cost curve on a website 118 for viewing by a user at a display device (not shown) associated with the client 116.

Block 440 is followed by block 442, in which the method 432 ends.

Note that methods 400, 420, and 432 can be performed for some or all items in a flow path or supply chain. Method 400 of FIG. 4A can be implemented for more than one type of item in a supply chain, where different types of items may be handled or otherwise processed in the supply chain. In such cases, additional functional blocks for receiving respective inventory data for the other types of items, storing the respective inventory data, determining demand factors and cost factors for the respective inventory data, determining a respective exchange curve, and displaying a portion of the respective inventory data and respective exchange curve for the other types of items can be implemented. Likewise methods 420 and 432 can be implemented as needed for respective types of items as needed.

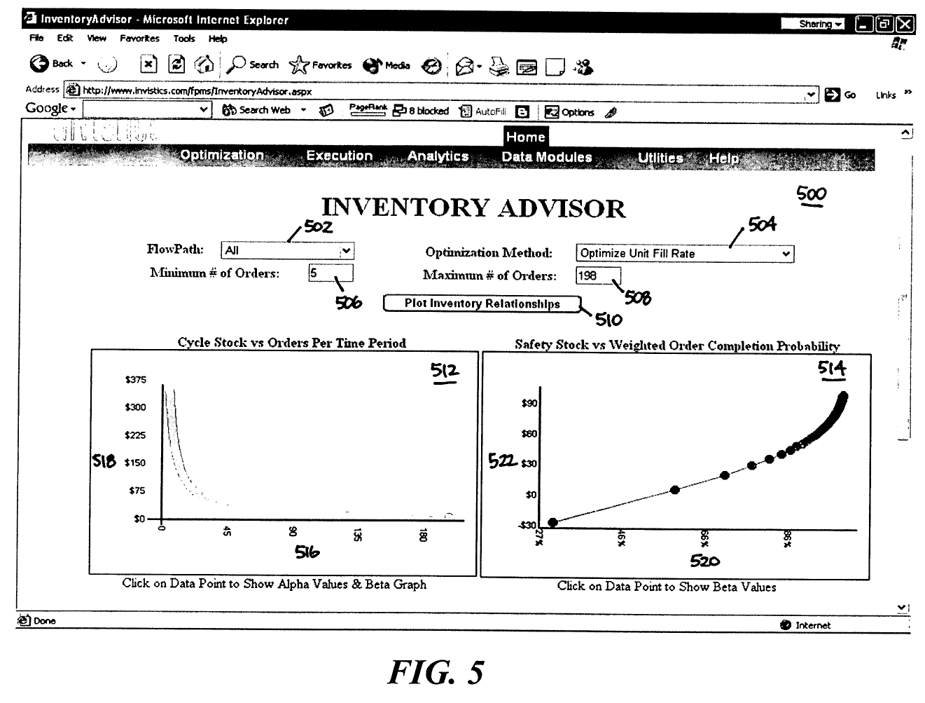

FIG. 5 is an upper portion of a screenshot of an exemplary user interface for methods and systems according to various embodiments of the invention. The upper portion of the screenshot illustrates a user interface 500 for an inventory advisor module 210 associated with a flow point management system (FPMS) application program 112. The inventory advisor module 210 provides the user interface 500. The user interface 500 includes a series of selection devices 502-510 for receiving a user input such as selection data. Each selection device 502-510 receives selection data such as flow path 502, optimization method 504, minimum number of orders 506, maximum number of orders 508, and a plot inventory relationships button 510. For example, the user interface 500 can be displayed by the inventory advisor module 210 on a website 118 hosted by the web server 108 in communication with the network 102. A user operating client 116 can access the user interface 500 via the browser application program 124. A user input via input device 126 is received by the selection device 502-510. Thus, in the example shown, a user could input the selection “All” to selection device 502 corresponding to flow path, the selection “Optimize Unit Fill Rate” to selection device 504 corresponding to optimization method, the number “5” to selection device 506 corresponding to the minimum number of orders, and the number “198” to selection device 508 corresponding to the maximum number of orders. Other selections, numbers, or quantities can be entered or input. Selection devices include, but not limited to, pull down menus, text fields, buttons, radio buttons, or other similar devices. Note that other selection devices to collect various types of selection data can be utilized in accordance with embodiments of the invention.

The user interface 500 also includes one or more exchange curves 512, 514. The inventory advisor module 210 determines an exchange curve based in part on inventory data received by the module 210, and in some instances based on data selection data received via the selection devices 502-510. When the exchange curve 512, 514 is determined for a particular set of inventory data and/or selection data, the inventory advisor module 210 displays the exchange curve 512, 514 on the screen interface adjacent to the selection devices 502-510.

In this example, selection data can be received with respect to all flow paths via selection device 502. Options for selection data associated with a flow path can include, but are not limited to, selecting a particular predefined flow path, or selecting all flow paths. Selection data can also be received with respect to an optimization method via selection device 504. Options for selection data associated with an optimization method can include, but are not limited to, optimize unit fill rate, optimize dollar fill rate, minimize number of shortages, and equal service levels for all items. These optimization methods are further described with respect to FIG. 7. Other selection data can be received with respect to minimum number of orders. Options for selection data associated with a minimum number of orders can include, but are not limited to, a predefined number of orders. Other selection data can be received with respect to minimum number of orders via selection device 506. Options for selection data associated with a minimum number of orders can include, but are not limited to, a predefined number of orders. Other selection data can be received with respect to a maximum number of orders via selection device 508. Options for selection data associated with a maximum number of orders can include, but are not limited to, a predefined number of orders. Via selection device 510, selection data associated with a user's desire to plot or graph an inventory relationship such as an exchange curve can be entered. In this example, a user may input new selection data via any combination of selection devices 502-508, and then request an updated exchange curve via selection device 510 based on the new selection data. The inventory advisor module 210 receives the new selection data, and updates one or more exchange curves 512, 514 based in part on the new selection data.

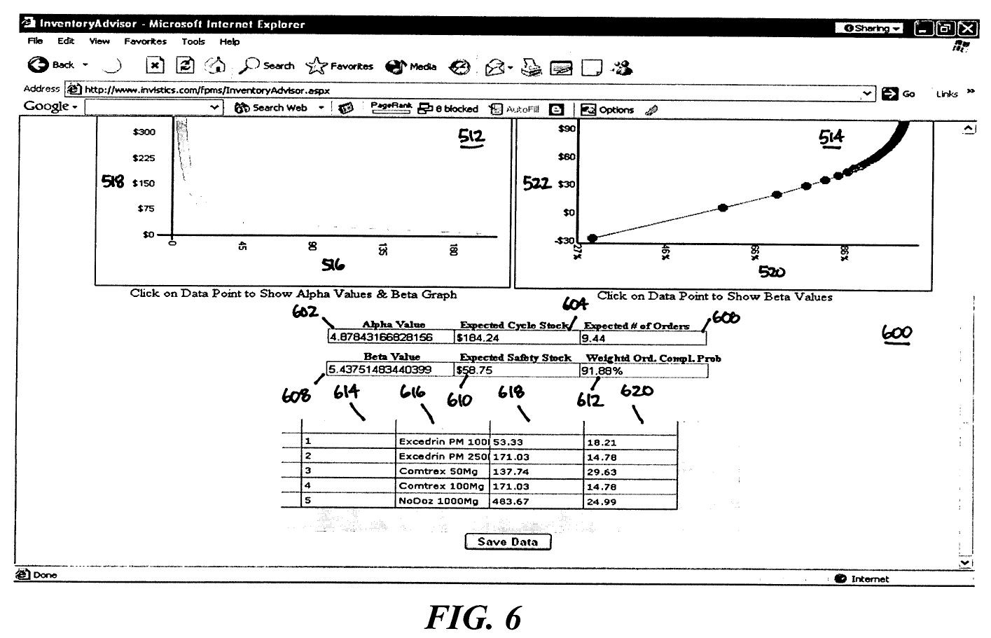

The exchange curves 512, 514 shown in this example, respectively illustrate cycle stock versus orders per time period, and safety stock versus weighted order completion probability. The first exchange curve 512 includes a number of orders per time period along a horizontal x-axis 516, and a cycle stock value along a vertical y-axis 518. The exchange curve 512 is plotted with respect to each axis 516, 518 for a particular set of inventory data and selection data. As shown and described in FIG. 6, a user can select a particular point along or adjacent to the exchange curve 512 and make an inventory decision based on the exchange curve 512. Likewise, the second exchange curve 514 includes a weighted order completion probability along a horizontal x-axis 520, and a safety stock value along a vertical y-axis 522. The exchange curve 514 is plotted with respect to each axis 520, 522 for a particular set of inventory data and selection data. As shown and described in FIG. 6, a user can select a particular point along or adjacent to the exchange curve 514 and make an inventory decision based on the exchange curve 514. Note that other types of exchange curves can be plotted and displayed by the inventory advisor module 210 depending on the inventory data and/or selection data.

FIG. 6 is a lower portion of the screenshot shown in FIG. 5. The lower portion of the screenshot illustrates a user interface 600 for an inventory advisor module 210 associated with a flow point management system (FPMS) application program 112. The inventory advisor module 210 provides the user interface 600. The user interface 600 includes a series of display devices 602-620 for displaying inventory data, and a selection device 622 for receiving a user input such as selection data. The lower portion of exchange curves 512, 514 from the user interface 500 shown in FIG. 5 can also be seen in this screenshot. Each display device 602-620 receives display data from the inventory advisor module 210 such as an alpha value 602, expected cycle stock 604, expected number of orders 606, beta value 608, expected safety stock 610, weighted order completion probability 612, part number 614, description of part or item 616, reorder point 618, and reorder quantity 620. The selection device 622 shown is a save data button.

Similar to the user interface 500, the user interface 600 is also displayed by the inventory advisor module 210 on the website 118 and can receive selection data from a user operating the input device 126.

In this example, display data can be displayed with respect to an alpha value via display device 602. As explained above in an example of FIG. 2, an alpha value or A is optimized by the inventory advisor module 210 to meet a first constraint defined by inventory data and/or selection data. Display data can also be determined by the inventory advisor module 210 with respect to an expected cycle stock via display device 604. A value for expected cycle stock can be determined by the inventory advisor module 210 using inventory data and/or selection data. Other display data can be determined by the inventory advisor module 210 with respect to expected number of orders via display device 606. A value for expected number of orders can be defined by inventory data and/or selection data. Display data can be displayed with respect to a beta value via display device 608. As explained above in an example of FIG. 2, an beta value or b is optimized by the inventory advisor module 210 to meet a second constraint defined by inventory data and/or selection data. Display data can also be determined by the inventory advisor module 210 with respect to an expected safety stock via display device 610. A value for expected safety stock can be determined by the inventory advisor module 210 using inventory data and/or selection data. Other display data can be determined by the inventory advisor module 210 with respect to weighted order completion probability via display device 612. A value for weighted order completion probability can be determined by the inventory advisor module 210 by using inventory data and/or selection data.

Associated display data can be shown by display devices 614-620. In display device 614, a part number is displayed by the inventory advisor module 210. Associated with the part number is a description of the part or item displayed by the inventory advisor module 210 in display device 616. For each part number and associated part description, the inventory advisor module 210 determines a reorder point and reorder quantity based in part on the inventory data and/or user selection data. The reorder point and reorder quantity are shown in display devices 618 and 620 respectively.

Via selection device 622, a user can save some or all of the displayed data associated with an inventory relationship such as an exchange curve, reorder points, or reorder quantities. In this example, a user may store data by entering an input to selection device 622, which stores some or all of the displayed data for future reference. The inventory advisor module 210 stores the displayed data in a relational database 106, memory 114, or another memory or data storage device for subsequent use or reference.

A portion of the exchange curves 512, 514 shown in this screen shot are also shown in FIG. 5. Using the input device 126, a user can select a particular point along or adjacent to either or both exchange curves 512, 514 and select an inventory decision based on either or both exchange curves 512, 514. For example, with the input device 126, a user can highlight a point along exchange curve 512, a window (not shown) can display an x-coordinate and a y-coordinate, each corresponding to a value on the x-axis 516 and y-axis 518 respectively. Using the overall representation of the exchange curve 512 and displayed data associated with the exchange curve 512, such as the alpha value 602, expected cycle stock 604, and expected number of orders 606, the user can enter or input an inventory decision.

FIG. 7 is another screenshot of an exemplary user interface for methods and systems according to various embodiments of the invention. As described above in FIG. 5, selection data can also be received with respect to an optimization method via selection device 504. As shown in FIG. 7, a user interface 700 displays various options for an optimization method such as optimize unit fill rate 702, optimize dollar fill rate 704, minimize number of shortages 706, and equal service levels for all items 708.

By way of example, an optimization method such as optimize unit fill rate 702 sets safety stocks to maximize the percentage of units demanded that are filled from stock. Because different items will vary according to their lot sizes, demand rates and demand variability, optimizing the aggregate service may result in different service levels by item.

By way of further example, an optimization method such as optimize dollar fill rate 704 sets safety stocks to maximize the percentage of demand on a monetary basis that is filled from stock. Because different items will vary according to their unit values, lot sizes, demand rates and demand variability, optimizing the aggregate service may result in different service levels by item.

Further, an optimization method such as minimize number of shortages 706 sets safety stocks to minimize the number of replenishment cycles any item will stock out. Since we are looking at replenishment cycles, all outages, regardless of the number of items or their value, are treated equally. Because different items will vary according to their lot sizes, demand rates and demand variability, optimizing the aggregate service may result in different stock out probabilities for different items.

Another optimization method such as equal service levels for all items 708, also known as equal probability of stock out, sets a common probability of a stock out per replenishment cycle, such as one in 20 cycles, which would be 95% service, for all items. Since we are looking at stock out cycles, all outages, regardless of the number of items or their value, are treated equally, thus there are equal service levels for all items. Every item is subject to the same outage probability, which may not minimize the total number of outages.

Note that other optimization methods in accordance with various embodiments of the invention can also be implemented.

As a user manipulates the input device on selection device 504, each option is highlighted. When the user selects the option, a signal corresponding to the user's selected option is sent to the website 118 and then transmitted to the inventory advisor module 210 for processing.

Referring back to FIG. 2, another module associated with the FPMS application program 112 is a lot size and work in progress (WIP) estimator module 216, or “LWE” module. This module 216 is adapted to determine and to set lot sizes that minimize time in a flow path. The LWE module 216 is further adapted to determine when throughput rates for items are feasible. That is, given desired throughput rates for one or multiple items or products, the LWE module 216 determines whether the throughput rates are feasible, and if so, finds the lot sizes for particular items that minimize the average cycle time to an “optimum” cycle time, aggregated over products. Given this optimum average cycle time, the LWE module 216 then implements a system-wide work-in-progress (WIP) level to use, for example, in a CONWIP or Kanban control scheme.

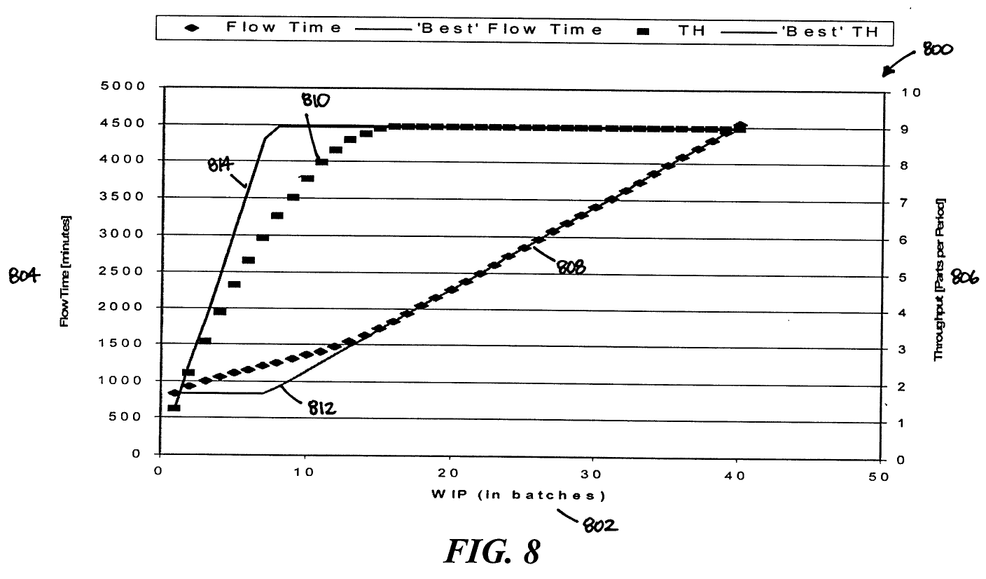

Furthermore, the LWE module 216 is adapted to generate graphical plots of selected routing data. Repeatedly used over multiple collections of throughput rates, the LWE module 216 produces graphical plots such as FIG. 8, depicting various tradeoffs between throughput rate, WIP level and average aggregate cycle time.

An example algorithm utilized by the LWE module 216 is adapted to determine appropriate lot sizes for one or multiple items in a supply chain. The algorithm described below can be implemented in an iterative manner as needed. First, in an initialization stage, the vector of lot sizes is initialized in a strategic manner, e.g. selecting current lot sizes. Next, in an estimation and evaluation stage, resulting cycle times are estimated and evaluated. In an improvement stage, the direction of steepest improvement (for the aggregate cycle time) is determined and a new vector of lot sizes is selected. Any combination of these steps and stages can be repeated as needed until an optimum lot size is determined.

Although data output of a LWE module 216 is adapted for use in at least partially “closed” inventory systems, the LWE module 216 can be implemented with “closed” and “open”-type inventory systems when estimating the lot sizes. For example, the following algorithms can be utilized for both types of inventory systems.

Assume particular items are denoted as i=, . . . , N and stations are denoted as j=1, . . . , J. In this example, there are at least five types of data inputs to the inventory system:

dᵢ—the demand rate for item i (parts per hour)

mᵢⱼ—the average processing time for item i at station j (hours per part)

σᵢⱼ^{m}—the standard deviation of processing time for item i at station j

sᵢⱼ—the average setup time for item i at station j (hours per setup)

σᵢⱼ^{s}—the standard deviation of setup time for item i at station j

For each station j, “productive utilization” can be determined as:

$${u}_{j} = {\sum }_{i = 1}^{N} {d}_{i} {m}_{ij}$$

The quantity uⱼ represents the long run fraction of time station j must be busy processing parts, independent of the time spent performing changeovers. In the above algorithm, the lot sizes for a given item are set to be the same across all stations.

In another algorithm, the resulting lot sizes may differ across stations. The lot sizes at the first station are determined differently than at subsequent stations. In an initialization stage, we set the lot sizes for a first station as follows:

$${Q}_{ij} = \frac{\sqrt{{s}_{i1}^{2} + 2 {s}_{i1} {W}_{i1}^{*}}}{{m}_{i1}} , \qquad ( 3.1 )$$

where W*ᵢₗ is a lower bound on the average queue time at station j, and Qᵢⱼ is the resulting lot size for product i at station j. The algorithm above includes modeling assumptions that item arrivals to the single station system are Poisson, and that item arrivals come in batches whose sizes are dictated through a control-type mechanism.

For downstream stations, a number of alternatives algorithms can also be used. One alternative includes setting “production runs” at each station equal, where a type (i, j) production run is defined as the total time (setups excluded) dedicated to the processing of a lot for item i at station j. That is, for station j and items i and k,

Qᵢⱼmᵢⱼ=ŷ_{j=Q}ₖⱼmₖⱼ, (3.2)

such that ŷⱼ is the common production run at station j. The variable ŷⱼ is set to achieve a heuristically chosen target “total utilization” of ûⱼ:

$${\hat{u}}_{j} = {\sum }_{i = 1}^{N} {d}_{i} ( {m}_{ij} + {s}_{ij} / {Q}_{ij} ) , \qquad ( 3.3 )$$

where û_{j=\sqrt{uⱼ}. Thus, solving for the lot sizes concludes the initialization stage and yields:}

$${Q}_{ij} = \frac{{\sum }_{k} {d}_{k} {s}_{kj} {m}_{kj}}{( \sqrt{{u}_{j}} - {u}_{j} ) {m}_{ij}} . \qquad ( 3.4 )$$

Next, in an estimation and evaluation stage, a cycle time estimation for each item is determined using a setup-time adaptation of the Queueing Network Analyzer (QNA)-type equations, developed by Whitt, with adjusted variability coefficients, proposed by Hopp and Spearman. A metric is then determined for the aggregate weighted flow, denoted f(Q) to emphasize an implicit dependence on the selected lot size vector Q.

In an improvement stage, a finite element analysis or method is used to estimate the gradient of the aggregate quantity, ∇f(\vec{Q}). The lot size vector is updated via the equation:

$${{Q}^{->}}_{1} = {{Q}^{->}}_{0} - \frac{∇ f ( {{Q}^{->}}_{o} )}{‖ ∇ f ( {{Q}^{->}}_{o} ) ‖} Δ , \qquad ( 3.5 )$$

where Δ is the selected step size, and the analysis is repeated in an iterative manner until a local minimum of ∇f(\vec{Q}) is determined.

Once the vector of lot sizes is determined, estimating a WIP level for the item is straightforward using Little's Law.

Note that the algorithms described above are similar to those provided in the prior example. In the above algorithm, assumptions were made that each item has a single lot size, regardless of the station. The above initialization stage includes solving equation 3.1 at a single station. Typically, this station is the station with the largest changeover times, but other stations may be selected. In any event, this lot size is then used at every station in the flow path or supply chain. In the improvement stage, the same lot size is maintained across stations.

Performance comparisons between conventional algorithms and algorithms implemented by a LWE module 216 can be made using heuristically chosen lot sizes from the initialization stage of the above algorithm. For example, a comparative analysis performed for a five item, five station system resulted in the following cycle times in Table 1:

TABLE 1
Resulting cycle times for heuristic and optimal lot sizes.

| | Heuristic | Optimal |
|---|---|---|
| Product 1 | 59 | 18 |
| Product 2 | 37 | 18 |
| Product 3 | 32 | 17 |
| Product 4 | 32 | 16 |
| Product 5 | 27 | 15 |
| Flow Time (hr) | 32.97 | 21.49 |

As seen in Table 1, the optimum cycle time achieved by adjusting lot sizes determined by the LWE module 216 is approximately 35% less than the cycle time achieved from using a conventional heuristic starting solution. The difference in performance shows that there is considerable improvement in cycle times to be gained, in terms of faster convergence to the optimum lot size, through an improved selection of the initial lot sizes. Note that when station-specific lot sizes can be selected, the optimal solution can also improve.

The LWE module 216 is also used to determine work in progress (WIP) levels in either a Kanban-type or CONWIP-type inventory system. Using a relatively fast “sample path” simulation technique, the LWE module 216 provides a graphical plot of the throughput versus the WIP level and the average cycle time versus the average WIP level. An example of a graphical plot provided by a LWE module 216 is shown as 800 in FIG. 8.

In FIG. 8, a horizontal x-axis 802 represents WIP by quantity of batches of goods or items. A left-side vertical y-axis 804 represents a cycle time for a lot in minutes. A right-side vertical y-axis 806 represents a throughput amount in parts per period. A first graphical plot 808 represents a particular WIP versus cycle time. A second graphical plot 810 represents a throughput for a particular good or item versus cycle time. Optimum or “best” results for each graphical plot are shown by graphical plots 812, 814 respectively Note that for a given WIP amount, a user may want to minimize cycle time. Using the two plots 808, 810, a user such as an inventory planner can set WIP levels that sufficiently set an amount of inventory throughput to meet demand while minimizing cycle times. In the particular example shown in FIG. 8, an optimum WIP level is approximately eight (8) batches.

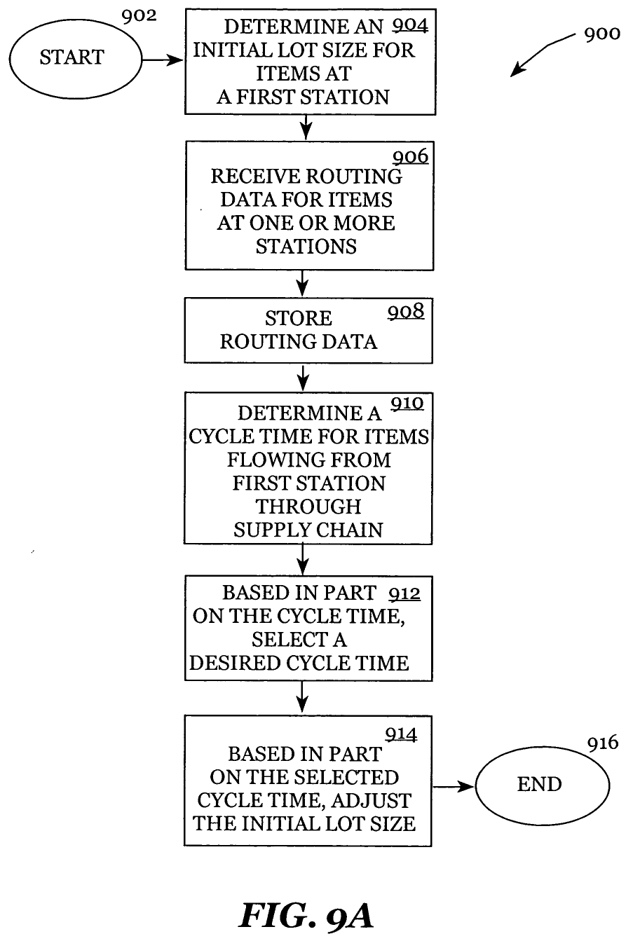

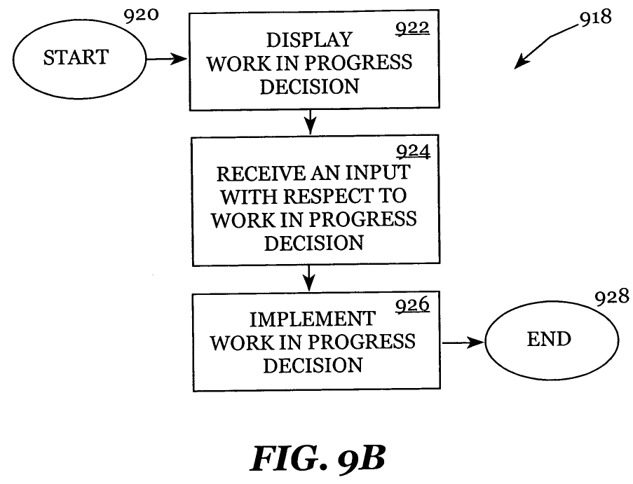

Referring to FIG. 9A, another exemplary method 900 according to various embodiments of the invention is shown. The method 900 is adapted to manage lot sizes of similar items in a supply chain. In the embodiment shown, the method 900 can be performed by the system embodiment shown as 100 in FIG. 1. By way of example, reference will be made to elements of the system 100 shown in FIG. 1.

In block 902, the method 900 begins.

Block 902 is followed by block 904, in which an initial lot size for items at a first operation is determined. A lot size and WIP estimator (LWE) module 216 determines an initial lot size for items at a first operation in a flow path or supply chain. Conventional methods and devices can be used to determine the initial lot size.

Block 904 is followed by block 906, in which routing data for items at each operation is received. The lot size and WIP estimator (LWE) module 216 receives routing data associated with items in the flow path via a network 102, an ERP server 128, ERP application program 140, or database 106, 144. Routing data can include, but is not limited to, performance measures, performance data, data inputs, selection data, lot size, flow time, delay time in the flow path, setup times, variability in setup times, process times, variability in process times, and yield loss.

Block 906 is followed by block 908, in which the routing data is stored. The LWE module 216 stores received inventory data in memory 114, or a relational database 106 for subsequent processing. Other memory or data storage type devices can be used in accordance with various embodiments of the invention.

Block 908 is followed by block 910, in which based on the routing data, a cycle time for the items flowing from the first station through the supply chain is determined. The LWE module 216 determines a cycle time for items flowing from the first station, based on previously stored or received routing data. For example, a cycle time can include, but is not limited to, the amount of time elapsed from the beginning of an operation on a particular item in a flow path to the completion of all operations for the item.

Block 910 is followed by block 912, in which based on at least the cycle time for the items flowing from the first station through the supply chain, a desired flow time for the items is determined. The LWE module 216 determines a desired cycle time for items in the flow path. By way of example, the LWE module 216 can utilize algorithms 3.1-3.5 shown above to determine a selected cycle time.

Block 912 is followed by block 914, in which based on at least the selected desired cycle time for the items, the initial lot size for the items at the first operation is adjusted. Once the LWE module 216 receives or otherwise determines a desired cycle time, the initial lot size for the items is adjusted as needed.

Block 914 is followed by block 916, in which the method 900 ends.

After method 900 adjusts the initial lot at block 916, another method 918 can be performed to utilize the desired cycle time. FIG. 9B illustrates the method 918.

At block 920, the method 918 begins. Block 920 is followed by block 922, in which at least one work in progress (WIP) decision with respect to a first type of item in the supply chain is displayed. After the LWE module 216 adjusts the initial lot size, the LWE module 216 can determine and display a curve such as an inventory quantity of a particular type of item versus throughput of work in progress. A user can view various performance points along or adjacent to the curve. Each point represents an operating point associated with various performance measures that the inventory system can operate at. Using an input device 126 at a client 116, the user can highlight or select a point along or adjacent to the exchange curve. When the user highlights or selects a particular point, performance data associated with the particular point along or adjacent to the curve is displayed. The performance data associated with the particular point represents a potential work in progress (WIP) decision that the user can select. A work in progress (WIP) decision can include, but is not limited to, decreasing the throughput of work in progress with respect to a particular type of item, and increasing the throughput of work in progress with respect to a particular type of item.

Block 922 is followed by block 924, in which a user input corresponding to an work in progress (WIP) decision is received. If the user decides upon a particular point along or adjacent to a curve as described above, the user selects the point by transmitting a data input via the input device 126. The client 116 transmits associated information corresponding to the work in progress (WIP) decision with respect to the point along or adjacent to the curve.

Block 924 is followed by block 926, in which depending on the work in progress (WIP) decision, the work in progress (WIP) decision is implemented with respect to particular items in a flow path or supply chain. The website 118 receives the data input from the client 116, and transmits the data input to the FPMS application program 112. The FPMS application program 112 transmits commands to a flow path or a supply chain that corresponds with the work in progress (WIP) decision selected by the user.

Block 926 is followed by block 928, in which the method 918 ends.

Note that methods 900, 918 can be performed for some or all items in a flow path or supply chain. Method 900 of FIG. 9A can be implemented for more than one type of item in a supply chain, where different types of items may be handled or otherwise processed in the supply chain. In such cases, additional functional blocks for receiving respective routing data for the other types of items, storing the respective routing data, determining cycle times based on the respective routing data, determining a respective selected cycle time, and displaying a portion of the respective routing data for the other types of items can be implemented. Likewise method 918 can be implemented as needed for respective types of items as needed.

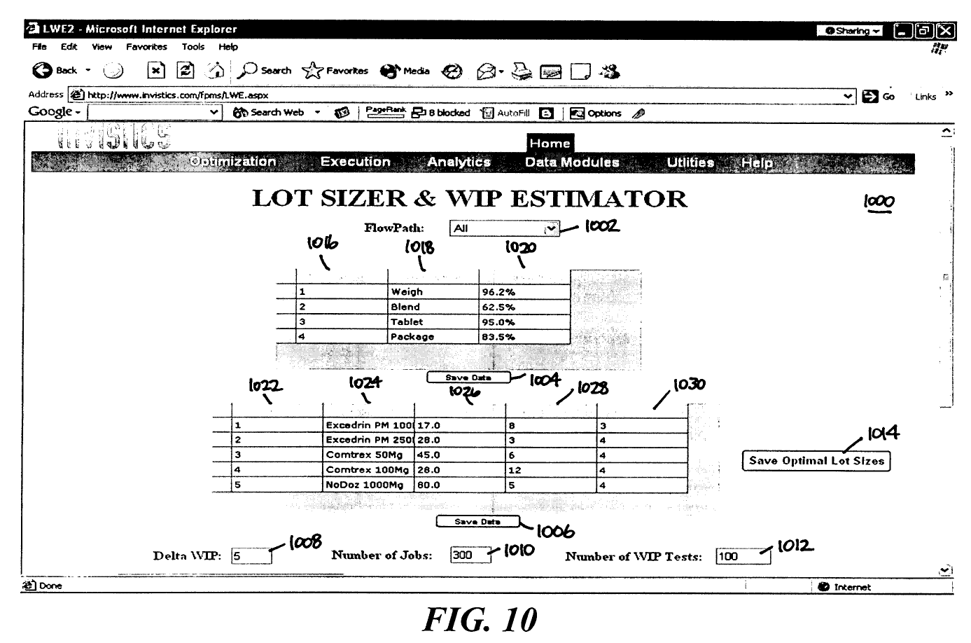

FIG. 10 is an upper portion of a screenshot of an exemplary user interface for methods and systems according to various embodiments of the invention. The upper portion of the screenshot illustrates a user interface 1000 for a LWE module 216 associated with a flow point management system (FPMS) application program 112. The LWE module 216 provides the user interface 1000. The user interface 1000 includes a series of selection devices 1002-1014 for receiving a user input such as selection data. Each selection device 1002-1014 receives selection data such as flow path 1002, save data 1004, 1006, delta WIP 1008, number of jobs 1010, number of WIP tests 1012, and save optimal lot sizes 1014. For example, the user interface 500 can be displayed by the LWE module 216 on a website 118 hosted by the web server 108 in communication with the network 102. A user operating client 116 can access the user interface 1000 via the browser application program 124. A user input via input device 126 is received by the selection device 1002-1014. Thus, in the example shown, a user could input the number “5” to selection device 1008 corresponding to delta WIP, the number “300” to selection device 1010 corresponding to number of jobs, and the number “100” to selection device 1012 corresponding to the number of WIP tests. Other numbers or quantities can be entered or input. Selection devices include, but not limited to, pull down menus, text fields, buttons, radio buttons, or other similar devices. Note that other selection devices to collect various types of selection data can be utilized in accordance with embodiments of the invention.

The user interface 1000 also includes a series of display devices 1016-1030 for displaying inventory data. Each display device 1016-1030 receives display data from the LWE module 216 such as work center ID 1016, work center description 1018, utilization rate 1020, part number 1022, part description 1024, demand quantity 1026, current lot size 1028, and optimal lot size 1030.

In this example, the LWE module 216 displays display data with respect to a work center ID via display device 1016. The work center ID can correspond to particular station in a flow path or supply chain numbered 1, 2, 3, 4, etc. Other unique identification characters can be used. Display data can also be displayed by the LWE module 216 with respect to a work center ID description via display device 1018, such as weigh, blend tablet, and package. Other descriptions can be used. A utilization rate determined by the LWE module 216 using routing data and/or selection data can be displayed via display device 1020. A part number can be displayed by the LWE module 216 via display device 1022. Part numbers can be sequentially numbered such as 1, 2, 3, etc. or otherwise uniquely identified. Display data for part number description can be displayed by the LWE module 216 via display device 1024. A demand value determined by the inventory advisor module 210 using routing data and/or selection data can be displayed via display device 1026. A current lot size determined by the inventory advisor module 210 can be displayed via display device 1028. A value for optimal lot size can be determined by the inventory advisor module 210 using routing data and/or selection data, and displayed via display device 1030.

Note that in this example, for each work center ID and description shown, LWE module 216 determines a utilization rate based in part on the routing data and/or user selection data. The respective utilization rates are shown in display device 1020 respectively. Likewise for each part number and part description shown, the LWE module 216 determines a demand quantity, a current lot size, and an optimal lot size based in part on the routing data and/or user selection data. The respective demand quality, current lot sizes, and optimal lot sizes are shown in display devices 1026, 1028, 1030 respectively.

Via selection devices 1004, 1006, and 1014, a user can save some or all of the displayed data associated with lot sizes for particular parts or items. In this example, a user may store utilization rate data by entering an input to selection device 1004, which stores some or all of the displayed data for future reference. The LWE module 216 stores the displayed data in a relational database 106, memory 114, or another memory or data storage device for subsequent use or reference. Likewise, data associated with demand, current lot size, and optimal lot size can be stored by entering an input to selection devices 1006 and/or 1014.

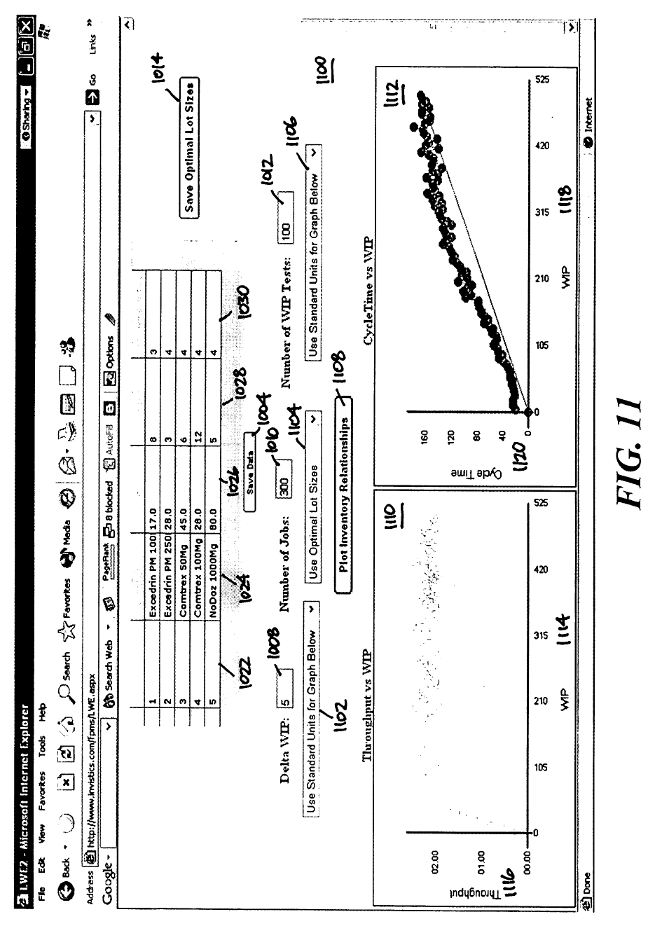

FIG. 11 is a lower portion of the screenshot shown in FIG. 10. The lower portion of the screenshot illustrates a user interface 1100 for a LWE module 216 associated with a flow point management system (FPMS) application program 112. The LWE module 216 provides the user interface 1100. The user interface 1100 includes a series of selection devices 1102-1108 for receiving a user input such as selection data, and one or more display devices 1110, 1112 for displaying data for viewing by a user. Selection devices 1006-1014 and display devices 1022-1030 from the user interface 1000 shown in FIG. 5 can also be seen in this screenshot.

The screen interface 1100 also includes one or more curves shown in display devices 1110-1112. The LWE module 216 determines one or more curves based in part on routing data received by the module 216, and in some instances based on data selection data received via the selection devices 1002, 1008-1012, 1102-1106. When a curve is determined for a particular set of routing data and/or selection data, the LWE module 216 displays the curve on a corresponding display device 1110, 1112 adjacent to the selection devices 1102-1108.

In this example, selection data can be received with respect to units for a graphical plot in display device 1110 via selection device 1102. Options for selection data associated with units for a graphical plot in display device 1110 can include, but are not limited to, standard units, predefined units, and user defined units. Selection data can also be received with respect to lot sizes via selection device 1104. Options for selection data associated with lot sizes can include, but are not limited to, optimal lot sizes, current lot sizes, predefined lot sizes, and user defined lot sizes. Selection data can be received with respect to units for a graphical plot in display device 1112 via selection device 1106. Options for selection data associated with units for a graphical plot in display device 1112 can include, but are not limited to, standard units, predefined units, and user defined units. Via selection device 1108, selection data associated with a user's desire to plot or graph a lot size relationship such as a curve can be entered. In this example, a user may input new selection data via any combination of selection devices 1002, 1008-1012, 1102-1106, and then request a curve via selection device 1108 based on the new selection data. The LWE module 216 receives the new selection data, and updates one or more curves shown in display devices 1110, 1112 based in part on the new selection data.

The curves shown in display devices 1110, 1112 in this example, respectively illustrate throughput versus work in progress, and cycle time versus work in progress. The first curve shown in display device 1110 includes a quantity of work in progress along a horizontal x-axis 1114, and a quantity of throughput along a vertical y-axis 1116. The curve is plotted with respect to each axis 1114, 1116 for a particular set of routing data and selection data. A user can then select a particular point along or adjacent to the curve and make a work in progress decision based on the curve shown in display device 1110. Likewise, the second curve shown in display device 1112 includes quantity of work in progress along a horizontal x-axis 1118, and cycle time along a vertical y-axis 1120. The curve is plotted with respect to each axis 1118, 1120 for a particular set of routing data and selection data. A user can then select a particular point along or adjacent to the curve shown in display device 1112, and select a work in progress decision based on the curve shown in display device 1112. Note that other types of curves can be plotted and displayed by the LWE module 216 depending on the routing data and/or selection data. A work in progress decision can include, but is not limited to, decreasing the throughput of work in progress with respect to a particular type of item, and increasing the throughput of work in progress with respect to a particular type of item.

Referring back to FIG. 2, another module associated with the FPMS application program is a promise date finder (PDF) module 222. The PDF module 222 is adapted to determine a promise data for an incoming order. The PDF module 222 is further adapted to determine viable promise dates that ensure both sufficient capacity and on time delivery to customers of purchased components. Unlike conventional MRP-type and Capacity Requirements Planning-type (CRP) systems, the PDF module 222 is adapted to perform both of these types of analyses simultaneously. For example, when PDF module 222 is utilized with an inventory system for managing purchased parts, the PDF module 222 operates similar to MRP-type systems by using an assumption that a constant lead time is appropriate. The PDF module 222 is adapted to consider an inventory system as it currently exists when determining an available date. The PDF module 222 is further adapted to receive lot size data from the LWE module 216 that minimizes cycle times. Thus, if conditions change, due dates may no longer be feasible, but future commitments can be determined using up-to-date information.

Moreover, once a feasible schedule is in place, the PDF module 222 is adapted to check for any new orders as they are being placed. For example, an order entry function could be moved to the website 118 shown in FIG. 1 in which a user could select desired delivery dates for goods or items based on the user's needs and willingness to pay for expedited service.

The PDF module 222 is adapted to manage the release jobs in an inventory system. Unlike MRP within ERP, the PDF module 222 does not thrust jobs into a line based on a “release” date. Instead the PDF module 222, “pulls” the jobs into the line using a CONWIP-type protocol. This type of protocol is simple and effective. By way of example, as shown in FIG. 8, once there are 15 lots in a line, increasing work in progress (WIP) does little to increase the throughput. It does, however, greatly increase cycle time. Thus, the CONWIP level in this case would be 15 lots. A new lot could be started by the PDF module 222 whenever the number of lots falls below approximately 15. The result is a near constant work in process level, also known as “CONWIP.” CONWIP-type protocols have been shown to outperform most other inventory and production dispatch systems in terms of throughput for a given WIP limit and is relatively easy to implement. The reason is that releasing work before the WIP level drops only adds to the queue before the bottleneck resource. The lot usually will not finish any earlier than if one had waited until the WIP level fell. By releasing earlier, there is a loss in overall flexibility (i.e., the ability to change what is released) and also in the predictability of the CONWIP-type system. Note that the PDF module 222 and FPMS application program 112 operate equally well for companies with Kanban-type or CONWIP-type systems.

The PDF module 206 is further adapted to dispatch jobs. For example, the PDF module 206 assigns a set of jobs a sequential number. The assignment of sequential numbers indicates a desired finish sequence of the jobs based on due dates and material requirements (e.g., assembly systems), with the lower number indicating either or both an immediate due date and higher material requirements. Although the jobs do not always finish in this sequence because of passing in the flow path, the sequence provides one way to choose which job in a queue should be performed next. The PDF module 206 then determines “expected” completion times for each job. Based on an expected completion time plus a safety factor, the PDF module 206 determines a promise date. Establishing due dates using a safety factor that provides the same probability of completion by the due date is optimal with respect to minimizing expected quoted lead times subject to a constraint on service. Thus the PDF module 206 is used to check and quote delivery dates and to determine material availability.

The PDF module 222 is further adapted to determine and to quote delivery dates to customers in real time. This contrasts to Advanced Planning and Scheduling (APS) systems that require long computer runs to optimize a schedule already generated by a MRP-type system. Thus, the PDF module 222 determines a feasible and efficient schedule instead of accepting orders using overly simplistic “available to promise” logic, and then trying to repair a poor or inefficient schedule using a complex and lengthy optimization procedure. Such a procedure can be provided by a PDF module 222, and accessed directly by customers via a network 102 without assistance. Thus, realistic ship dates and efficient, feasible schedules can be determined.

An example of a set of algorithms implemented by a PDF module 222 is as follows. Other algorithms can be used including some or all of the algorithms described below.

Let existing jobs be denoted i=1, . . . , N and stations denoted j=1, . . . , J. Time periods k=1, . . . , K are defined for potential promise dates, and the same time periods designated p=1, . . . , K for capacity calculations. In this example, there are four data inputs:

mᵢⱼ —the average processing time for product i at station j (hours per part)

sᵢⱼ—the average setup time for product i at station j (hours per setup)

aⱼₚ—the time available for production at station j in a single period p. (This is the capacity available in each period, and is input for each period p=1, . . . , K.)

Dᵢ—the due date period for job i.

For each station j, “cumulative available capacity” at station j can be determined, up to and including period k, as

$${Ω}_{jk} = {\sum }_{p = 1}^{k} {a}_{jp} .$$

Calculating “booked capacity” for existing orders includes four computational steps performed prior to accepting new orders. First, “remaining cycle time” for each job after each station is estimated, Fᵢⱼ, using either historical actual cycle times, if available, or using the approximations similar to those described above with respect to the LWE module 216. Next, a “latest task completion date” is determined for each job, i, at each station, j, visited:

Tᵢⱼ=Dᵢ−Fᵢⱼ (4.1)

Next, “hours booked” at each station j, in each period, p, are calculated by adding the time required for all jobs that should visit that particular station in that particular period:

$${ψ}_{jp} = {\sum }_{i = 1}^{N} ( {m}_{ij} + {s}_{ij} ) {N}_{ijp} \qquad ( 4.2 )$$

where Nᵢⱼₚ=1 if job i should visit station j in period p (Tᵢⱼ=p) and Nᵢⱼₚ=0 otherwise. (Note that this is a conservative estimate of setup times, as it assumes no setup pooling between similar jobs.) Finally, the “cumulative booked capacity” at each station j through each period k is calculated:

$${Ψ}_{jk} = {\sum }_{p = 1}^{k} {ψ}_{jp} \qquad ( 4.3 )$$

A difference between the cumulative available capacity and booked capacity is then calculated to determine the time that is not yet booked and is still available for new orders. To determine the quantity that can be booked for incoming job i to be completed by period, k, the following equation is used:

$${θ}_{ik} = {min}_{j ∈ {V}_{i}} \{ ( {Ω}_{jt} - {Ψ}_{jt} - {s}_{ij} ) {m}_{ij} \} \qquad ( 4.4 )$$

where t=k−Fᵢⱼ calculated to offset the expected cycle time for job i remaining after station j, and Vᵢ is the set of stations visited by job i.

By knowing the quantity that can be promised in each period, a “minimum lead time” is determined that can be quoted. A search is then conducted over all periods to find the maximum (latest) period, kₘₐₓ where Θᵢₖ <0. This search has the effect of bypassing early periods with “unbooked capacity” if later periods have no “cumulative unbooked capacity.” The “minimum lead time” is the following period, or kₘₐₓ+1.

Thus, using these or other algorithms, a PDF module 222 can retrieve capacity and order book information. Lead times for all incoming orders can also be quoted that ensure capacity exists at all required work centers. In at least one instance, delivery performance for a company has increased from approximately 65% to 95%, due in part to the PDF module's 222 ability to minimize overbooking capacity.

Referring to FIG. 12, another exemplary method 1200 according to various embodiments of the invention is shown. The method 1200 is adapted to determine a promise date for a job in producing items in a supply chain. In the embodiment shown, the method 1200 can be performed by the system embodiment shown as 100 in FIG. 1. By way of example, reference will be made to elements of the system 100 shown in FIG. 1.

In block 1202, the method 1200 begins. Block 1202 is followed by block 1204, in which a production time for an item at a station is determined. The PDF module 206 determines a production time for an item at a station from performance data, routing data, and/or selection data received from an ERP application program 140, memory 114, 142, relational database 106, 144, network 102, user, or another source. For example, the data used to determine the production time is described above with respect to algorithms 4.1-4.4. Other algorithms could be used in accordance with various embodiments of the invention.

Block 1204 is followed by block 1206, in which a setup time for the item at the station is determined. The PDF module 206 determines a setup time for an item at a station from performance data, routing data, and/or selection data received from an ERP application program 140, memory 114, 142, relational database 106, 144, network 102, user, or another source. For example, the data used to determine the setup time is described above with respect to algorithms 4.1-4.4. Other algorithms could be used in accordance with various embodiments of the invention.

Block 1206 is followed by block 1208, in which cumulative available capacity is determined. The PDF module 206 determines a cumulative available capacity from performance data, routing data, and/or selection data received from an ERP application program 140, memory 114, 142, relational database 106, 144, network 102, user, or another source. For example, the data used to determine the cumulative available capacity is described above with respect to algorithms 4.1-4.4. Other algorithms could be used in accordance with various embodiments of the invention.

Block 1208 is followed by block 1210, in which booked capacity is determined. The PDF module 206 determines a booked capacity from performance data, routing data, and/or selection data received from an ERP application program 140, memory 114, 142, relational database 106, 144, network 102, user, or another source. For example, the data used to determine the booked capacity is described above with respect to algorithms 4.1-4.4. Other algorithms could be used in accordance with various embodiments of the invention.

Block 1210 is followed by block 1212, in which a difference between the cumulative available capacity and booked capacity is determined, and then the difference is adjusted by at least the production time for an item at the station and setup time for the item at the station. The PDF module 206 determines a difference between the cumulative available capacity and booked capacity, determined above in blocks 1208 and 1210 respectively. Data for production time and setup time, determined at blocks 1204 and 1206 respectively, is then used by the PDF module 206 to adjust the difference. For example, the data used to determine the adjustments to the difference is described above with respect to algorithms 4.1-4.4. Other algorithms could be used in accordance with various embodiments of the invention.

Block 1212 is followed by block 1214, in which based in part on the difference, a minimum lead time for a job in producing items in a supply chain is determined. The PDF module 206 determines a minimum lead time for a particular job using performance data, routing data, and/or selection data received from an ERP application program 140, memory 114, 142, relational database 106, 144, network 102, user, or another source. For example, the data used to determine the cumulative available capacity is described above with respect to algorithms 4.1-4.4. Other algorithms could be used in accordance with various embodiments of the invention.

Block 1214 is followed by block 1216, in which the method 1200 ends.

The foregoing description of the preferred embodiments of the invention has been presented only for the purpose of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated.

The invention we claim is:

1. A method for managing inventory of similar items in a supply chain, the method comprising:
(a) determining a flow path for items in a supply chain, wherein the flow path comprises at least one operation;
(b) receiving inventory data for items at each operation;
(c) storing the inventory data;
(d) determining a demand factor for the items;
(e) determining a cost factor for the items;
(f) based in part on the demand factor and the cost factor, determining an exchange curve for the items; and
(g) displaying a portion of the inventory data for the items and the exchange curve.

2. The method of claim 1, further comprising:
(h) displaying at least one inventory decision with respect to the items in the supply chain;
(i) receiving a user input corresponding to the inventory decision; and
(j) depending on the inventory decision, implementing the inventory decision with respect to the items at an operation.

3. The method of claim 2, wherein the inventory decision is selected from a group consisting of: make an item to order and make an item to stock.

4. The method of claim 1, wherein (d) determining a demand factor for the items comprises determining a number of orders for the items over a predefined amount of time.

5. The method of claim 1, wherein (e) determining cost factor for the items comprises determining a total cycle stock cost for the items.

6. The method of claim 1, wherein (f) based in part on the demand factor and the cost factor, determining an exchange curve for the items comprises:
comparing a cycle stock inventory cost of the items in the supply chain with a number of orders for the items over a predefined period of time.

7. The method of claim 1, wherein (f) based in part on the demand factor and the cost factor, determining an exchange curve for the items comprises:
determining multiple exchange curves for the items.

8. The method of claim 2, further comprising:
(k) determining a reorder point and a reorder quantity for the items.

9. The method of claim 1, further comprising:
(h) determining investment in a safety stock and an expected number of stock outs over a period of a predefined amount of time;
(i) based on investment in the safety stock and expected number of stock outs per period of a predefined amount of time, determining a penalty cost curve; and
(j) displaying a portion of the inventory data for the items and the penalty cost curve.

10. A method for managing inventory of different types of items in a supply chain, the method comprising:
(a) receiving inventory data for items of a first type at an operation;
(b) receiving inventory data for items of a second type at an operation;
(c) storing the inventory data for the items of the first type and second type;
(d) determining demand factors for the items of the first type and second type;
(e) determining cost factors for the items for the items of the first type and second type;
(f) based in part on the demand factors and the cost factors, determining a first exchange curve for the items of the first type and a second exchange curve for the items of the second type; and
(g) displaying a portion of the inventory data for the items of the first and second types, and the exchange curves for the items of the first and second types.

11. A method for managing lot sizes of similar items in a supply chain, wherein the supply chain comprises at least one station, the method comprising:
(a) determining an initial lot size for items at a first station;
(b) receiving routing data for items at each station;
(c) storing the routing data;
(d) based on the routing data, determining a cycle time for the items flowing from the first station through the supply chain;
(e) based on at least the cycle time for the items flowing from the first station through the supply chain, selecting a desired cycle time for the items; and
(g) based on at least the selected desired cycle time for the items, adjusting the initial lot size for the items at the first station.

12. A method for managing lot sizes of multiple types of items in a supply chain, wherein the supply chain comprises at least one station, the method comprising:
(a) determining an initial lot size for a first type of item at a first station;
(b) determining an initial lot size for a second type of item at the first station;
(c) receiving routing data for each type of item as the items flow from the first station through the supply chain;
(d) storing the routing data;
(e) based on the routing data, determining a cycle time for each type of item flowing from the first station through the supply chain;
(f) based on at least the cycle time for the items flowing from the first station through the supply chain, selecting a desired cycle time for each type of item; and
(g) based on at least the desired cycle time for each type of item, adjusting the initial lot size for each type of item at the first station.

13. The method of claim 12, further comprising:
repeating elements (a)-(g) as needed.

14. The method of claim 12, wherein the selected desired cycle time is lower than the initial cycle time measured for a first item flowing from the first station through the supply chain.

15. The method of claim 12, further comprising:
(h) based on at least part of the routing data, determining a quantity of the first type of item processed at a second station and a throughput of work in progress of the first type of item as the item flows from the first station; and
(i) displaying a portion of routing data, the number of the first type of item processed at another station in the supply chain, and the throughput of work in progress of the first type of item as the item flows from the first station to the other station in the supply chain.

16. The method of claim 12, further comprising:
(h) displaying at least one work in progress decision with respect to the first type of item;
(i) receiving a user input corresponding to the work in progress decision; and
(j) implementing the work in progress decision with respect to the first type of item at the first station.

17. The method of claim 16, wherein the work in progress decision is selected from a group consisting of: decreasing the throughput of work in progress with respect to the first type of item, and increasing the throughput of work in progress with respect to the first type of item.

18. A method for determining a promise date for an incoming order, wherein the supply chain comprises at least one station, the method comprising:
(a) determining production time for an item at a station;
(b) determining setup time for the item at the station;
(c) determining cumulative available capacity;
(d) determining booked capacity;
(e) determining a difference between the cumulative available capacity and booked capacity, and adjusting the difference by at least the production time for an item at the station and setup time for the item at the station; and
(f) based in part on the difference, determining a minimum lead time for an incoming order.

19. The method of claim 18, wherein (c) determining cumulative available capacity comprises determining available time for additional production of the item at the station over a predefined amount of time.

20. The method of claim 18, wherein (d) determining booked capacity, comprises:
(1) determining a remaining time for each order after the station;
(2) determining a latest task completion date for each order at the station;
(3) determining order hours booked at the station over a predefined amount of time; and
(4) determining cumulative booked capacity at the station for a second predefined amount of time.

21. A method for managing a supply chain for multiple types of items, the method comprising:
(a) determining a flow path for each type of item in a supply chain, wherein each flow path comprises operations;
(b) receiving performance data for each type of item at each operation;
(c) storing the performance data;
(d) processing the performance data to obtain a determination selected from a group consisting of: an exchange curve, a lot size estimate, and a promise date; and
(e) displaying a portion of the performance data for the items and the determination.

22. A system for managing a supply chain for multiple types of items, comprising:
a flow path management system module adapted to:
determine a flow path for each type of item in a supply chain, wherein each flow path comprises operations;
receive performance data for each type of item at each operation;
store the performance data;
process the performance data to obtain a determination selected from a group consisting of: an exchange curve, a lot size estimate, and a promise date; and
display a portion of the performance data for the items and the determination.
